(19) United States
(12) Patent Application Publication
(10) Pub. No.: US 2014/0351079 A1
(43) Pub. Date: Nov. 27, 2014

(54) METHOD FOR RECOMMENDING A COMMODITY

(71) Applicant: University College Dublin, Dublin (IE)

(72) Inventors: Ruihai DONG, Dublin (IE); Michael P. O'Mahony, Dublin (IE); Barry Smyth, Wicklow (IE); Markus Schaal, Berlin (DE)

(73) Assignee: University College Dublin, Dublin (IE)

(21) Appl. No.: 14/286,760

(22) Filed: May 23, 2014

Related U.S. Application Data
(60) Provisional application No. 61/827,054, filed on May 24, 2013.

(51) Int. Cl. G06Q 30/06; G06Q 30/02

(52) U.S. Cl. CPC G06Q 30/0631; G06Q 30/0282
USPC 705/26.7

(57) ABSTRACT

A user inputs a request (1) for a commodity recommendation. A computer system accesses (2) a plurality of commodity reviews. The computer system extracts feature indicators (3) and sentiment indicators (4) from each commodity review. The computer system determines (5) the popularity of each feature indicator and the similarity between a first commodity (Q) and a second commodity (C). The computer system evaluates the sentiment indicators and evaluates the similarity indicator to form (7) the commodity recommendation. After the commodity recommendation has been formed in step (7), the computer system delivers (8) the commodity recommendation for the second commodity (C) to the user using a website interface.

### REFERENCE TO RELATED APPLICATION

This application claims priority from U.S. Provisional Application Ser. No. 61/827,054, filed May 24, 2013. The entirety of this provisional patent application is incorporated herein by reference.

### BACKGROUND

This invention relates to a method for recommending a commodity. In particular this invention relates to a method and system for product reviews and recommendations. The present invention relates generally to the field of product reviews and recommendations.

There is, at present, a large body of under-examined data sitting on websites in the form of reviews on websites such as Amazon.com®, TripAdvisor.com®, etc. This user-generated data contains detailed information about the products which focuses on product performance and features and usually expresses an opinion on the overall product and on specific features of a product. Currently, there is no easy way to corral this rich but messy data into a form where a meta-review can be generated which might eventually inform a purchase.

Existing product review systems may use the ranking, or “star,” system where a reviewer is asked to provide an overall number of marks out of ten, for example. This is usually all a casual reader can assimilate when looking for an opinion on a product without going through each individual review, and the finer detail of the reviews is, therefore, lost.

The content of existing reviews is therefore not being used effectively. User generated content in reviews is rich in nuance and opinion, and these details are lost in existing rating systems. This invention utilizes the user sentiment and definition of features contained in all written reviews of a product to generate an informed summary of the pros and cons of each feature. This allows the potential buyer to view a meta-review of the product that will aid in purchasing decisions. This invention could be used by, for example, manufacturers to find the most criticized aspect of their product in order to inform product development.

### SUMMARY

According to the invention there is provided a method for recommending a commodity comprising the steps of: accessing one or more commodity reviews; extracting one or more feature indicators from the one or more commodity reviews, each feature indicator being associated with a feature of a commodity; extracting one or more sentiment indicators from the one or more commodity reviews, each sentiment indicator being associated with a feature indicator, and evaluating the one or more sentiment indicators to form a commodity recommendation.

The commodity may be any physical product or any service provided to a consumer. For example, a physical product may be a television, or a digital camera, or an item of clothing, or the like to be purchased by a consumer. For example, a service may be attending a movie theatre, or transportation on an aircraft flight, or hotel accommodation, or the like to be purchased by a consumer.

The invention provides a recommendation to the consumer for the best or most suitable commodity appropriate to the needs of the consumer. The commodity review may be accessible to the consumer by means of a website interface. The commodity review stores the previous experiences of other consumers relating to the same or a similar commodity. By extracting the sentiment indicators and evaluating these sentiment indicators, this arrangement leverages the previous experiences of other consumers to provide a more nuanced and sophisticated recommendation to the consumer.

The invention provides a system for sentimental product recommendation. The invention is applicable to product recommendation that is based on opinionated product descriptions that are automatically mined from types of user-generated reviews that are commonplace on websites such as Amazon® and TripAdvisor®. The invention provides a recommendation ranking strategy that combines similarity and sentiment to suggest products that are similar but superior to a query product according to the opinion of reviewers.

In one embodiment of the invention the method comprises the step of receiving a request for a commodity recommendation. Preferably the request comprises a request indicator, the request indicator being associated with a first commodity. The invention uses the request indicator as an input query to recommend the same commodity or a similar commodity to the consumer. Ideally the request indicator comprises a string of text. Most preferably the one or more commodity reviews are accessed responsive to receiving the request.

In another embodiment the commodity review is pre-defined. Preferably the commodity review is defined by a consumer of the commodity. The commodity review stores the previous experiences of other consumers relating to the same or a similar commodity. Ideally the feature indicator is defined by a consumer of the commodity. In this manner the features used to evaluate the most appropriate commodity are not constrained to being the features considered by the provider of the commodity to be most important. The consumers themselves are allowed to dictate what the most important features of the commodity are from a user perspective. The commodity review may be defined by a provider of the commodity. The feature indicator may be defined by a provider of the commodity.

In one case a plurality of commodity reviews are accessed. This arrangement leverages the experiences of a plurality of other consumers in relation to a plurality of different commodities to provide a broader base to evaluate the best commodity. Preferably a first commodity review is associated with a first commodity. Ideally a second commodity review is associated with a second commodity. Most preferably the second commodity is different to the first commodity.

In another case extracting the feature indicator from the commodity review comprises performing natural language processing of the commodity review. Preferably extracting the feature indicator from the commodity review comprises performing shallow natural language processing of the commodity review.

In one embodiment evaluating the one or more sentiment indicators comprises classifying each sentiment indicator as being a positive sentiment indicator, a negative sentiment indicator, or a neutral sentiment indicator. Preferably evaluating the one or more sentiment indicators comprises determining the number of positive sentiment indicators associated with a first feature indicator. Ideally evaluating the one or more sentiment indicators comprises determining the number of negative sentiment indicators associated with the first feature indicator. Evaluating the one or more sentiment indicators may comprise determining the number of neutral sentiment indicators associated with the first feature indicator. Most preferably evaluating the one or more sentiment indicators comprises determining the difference between the number of positive sentiment indicators associated with the first feature indicator and the number of negative sentiment indicators associated with the first feature indicator. Evaluating the one or more sentiment indicators may comprise evaluating one or more sentiment indicators associated with a first commodity, and evaluating one or more sentiment indicators associated with a second commodity. Preferably evaluating the one or more sentiment indicators comprises determining the difference between the one or more sentiment indicators associated with the first commodity and the one or more sentiment indicators associated with the second commodity. Evaluating the one or more sentiment indicators may comprise determining the difference for each feature indicator in common between the first commodity and the second commodity. Preferably evaluating the one or more sentiment indicators comprises aggregating the differences for each feature indicator in common between the first commodity and the second commodity. Evaluating the one or more sentiment indicators may comprise determining the difference for each feature indicator of the first commodity and for each feature indicator of the second commodity. Preferably evaluating the one or more sentiment indicators comprises assigning a neutral sentiment indicator for each feature indicator not in common between the first commodity and the second commodity. Ideally evaluating the one or more sentiment indicators comprises aggregating the differences for each feature indicator of the first commodity and for each feature indicator of the second commodity.

In another embodiment a first feature indicator is extracted from a plurality of commodity reviews. Preferably the method comprises determining the number of commodity reviews from which the first feature indicator is extracted to form a popularity indicator. Ideally the method comprises determining a similarity indicator between a first commodity and a second commodity. Most preferably determining the similarity indicator comprises aggregating the popularity indicator for each feature indicator of the first commodity and aggregating the popularity indicator for each feature indicator of the second commodity. Determining the similarity indicator may comprise aggregating the popularity indicator for each feature indicator of the first commodity and aggregating the popularity indicator for each feature indicator of the second commodity in a cosine metric, or in a Jaccard metric, or in an overlap metric. Preferably the method comprises evaluating the similarity indicator to form the commodity recommendation. In this manner the invention ensures that the commodity recommended to the consumer is similar to the initial input query.

In one case the method comprises delivering the commodity recommendation. The commodity recommendation may be delivered to the consumer by means of a website interface display. Preferably the commodity recommendation comprises a recommendation indicator, the recommendation indicator being associated with a second commodity. Ideally the recommendation indicator comprises a string of text. The recommendation indicator may comprise an image. The method may comprise delivering an image derived from the commodity recommendation. The method may comprise delivering a graphical representation derived from the commodity recommendation. Most preferably the feature indicator comprises a string of text. The sentiment indicator may comprise a string of text.

The method may comprise delivering the feature indicator. The method may comprise delivering the sentiment indicator. The method may comprise delivering an interim result of evaluating the one or more sentiment indicators. The method may comprise delivering a final result of evaluating the one or more sentiment indicators. The method may comprise delivering the popularity indicator. The method may comprise delivering the similarity indicator.

The method may be a computer implemented method. One or more of the steps of the method may be automatically implemented by a computer system. Preferably all of the steps of the method are automatically implemented by a computer system.

The invention also provides in another aspect a system for recommending a commodity, the system comprising: a means for accessing one or more commodity reviews; means for extracting one or more feature indicators from the one or more commodity reviews, each feature indicator being associated with a feature of a commodity; means for extracting one or more sentiment indicators from the one or more commodity reviews, each sentiment indicator being associated with a feature indicator; and means for evaluating the one or more sentiment indicators to form a commodity recommendation.

The invention provides a recommendation to the consumer for the best or most suitable commodity appropriate to the needs of the consumer. The commodity review may be accessible to the consumer by means of a website interface. The commodity review stores the previous experiences of other consumers relating to the same or a similar commodity. By extracting the sentiment indicators and evaluating these sentiment indicators, this arrangement leverages the previous experiences of other consumers to provide a more nuanced and sophisticated recommendation to the consumer.

The system may be a computer implemented system.

The sentimental product recommendation system of the invention involves mining user-generated reviews for product recommendation, framing sentimental product recommendation, and sentiment-based recommendation.

The invention automatically trawls through a myriad of reviews to help make purchase decisions based on features and user sourced sentiment. The invention may be used as an analytic tool for consumers, manufactures, retailers. Online retailers such as Amazon® and NewEgg®, or travel sites such as TripAdvisor® or Expedia®, have large datasets of reviews on products or services. These reviews contain key information in relation to features and their performance, which can be used by a person or business to inform a purchase. The invention provides an easy way to corral this rich but myriad data from numerous reviews on a product or service, potentially sourced across several online companies, into a form where a meta-review can be generated which might eventually inform a purchase.

Reviews describe features as well as user-sentiment about those features. Generating an informed summary of the pros and cons of each feature across multiple reviews leads to the creation of a meta-review. A meta-review empowers a potential buyer to make an informed purchase decision based on multiple reviews for a product sourced from multiple sites.

A 3-step approach may be carried out for a given product. Firstly, shallow NLP techniques extract candidate features from reviews of a product. Secondly, associated sentiment for each feature is evaluated. Finally, features and overall sentiment scores are aggregated to generate experiential product meta-reviews. The recommendations can be made based on; Product Similarity (feature sets), Sentiment (performance), Combining Similarity with Sentiment (feature sets and performance).

The invention enjoys various benefits. Thousands of reviews for a product or service, sourced from multiple online sources, can be automatically aggregated to provide quick and powerful information. Manufacturers can inform product development using the information on feature sets and the sentiment regarding the feature sets. Potential buyers can use meta-reviews of a product to understand the product features as well as the features found in other products, as well as the sentiment in those features, to aid in purchasing decision.

There is also provided a computer program product comprising computer program code capable of causing a computer system to perform the above method when the computer program product is run on a computer system. The computer program product may be embodied on a record medium, or a carrier signal, or a read-only memory.

### BRIEF DESCRIPTION OF THE DRAWINGS

The invention will be more clearly understood from the following description of some embodiments thereof, given by way of example only, with reference to the accompanying drawings, in which:

FIG. 1 is a schematic flowchart of a method for recommending a commodity according to the invention;

FIG. 2 is a schematic flowchart of a part of the method of FIG. 1;

FIG. 3 is a schematic flowchart of another part of the method of FIG. 1;

FIG. 4 is a schematic representation of the method of FIG. 1;

FIG. 5 are cosine histograms of results of an example of the method of FIG. 1;

FIG. 6 are heat maps of results of the example of the method of FIG. 1;

FIG. 7 are plots of precision results of the example of the method of FIG. 1;

FIG. 8 are plots of benefit results of the example of the method of FIG. 1;

FIG. 9 is a plot of ratings benefit results of the example of the method of FIG. 1;

FIG. 10 is a schematic representation of another method for recommending a commodity according to the invention;

FIG. 11 are cosine histograms of results of an example of the method of FIG. 10;

FIGS. 12 and 13 are plots of benefit results of the example of the method of FIG. 10;

FIG. 14 is a plot of ratings benefit results of the example of the method of FIG. 10; and

FIG. 15 is a schematic representation of another method for recommending a commodity according to the invention.

### DETAILED DESCRIPTION

The present invention will now be described more fully hereinafter with reference to the accompanying drawings in which exemplary embodiments of the invention are shown. However, the invention may be embodied in many different forms and should not be construed as limited to the representative embodiments set forth herein. The exemplary embodiments are provided so that this disclosure will be both thorough and complete and will fully convey the scope of the invention and enable one of ordinary skill in the art to make, use, and practice the invention.

Websites like Amazon.com® and TripAdvisor.com® are often distinguished by their user-generated product or service reviews. Consumers often use such reviews even if the consumers do not purchase directly. The present invention describes a method and system for extracting “features” from these reviews to produce a detailed description of a product in terms of the features that are discussed in its reviews. Moreover, sentiment information can be extracted for product features to determine, for instance, that product X gets positive (or negative) reviews for feature Y. By way of example, a laptop computer may get a positive review for the feature “weight.”

This information is used to, among other things: (1) automatically generate review summaries to highlight the most popular positive and negative features as the pros and cons of a product; (2) visualize products and the product space in interesting ways to show the various review features and their sentiment; (3) determine similarities between products by comparing products in terms of their features and associated sentiment; and (4) produce a better recommendation by suggesting products that are similar to a given product based on their features and based on improved sentiment.

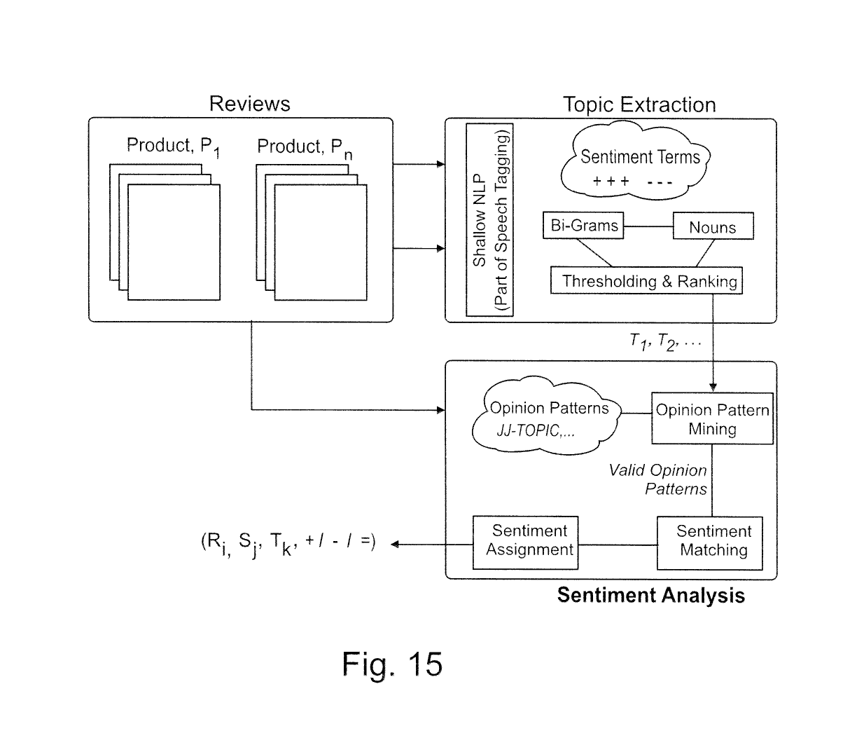

First, topics are mined from user-generated product reviews and sentiment is assigned to these topics on a per review basis. Then, topics are automatically extracted and assigned sentiments as per FIG. 15 describing the architecture for extracting topics and assigning sentiment. Then, these topics and sentiment scores are aggregated at the product level to generate a case of features and overall sentiment scores.

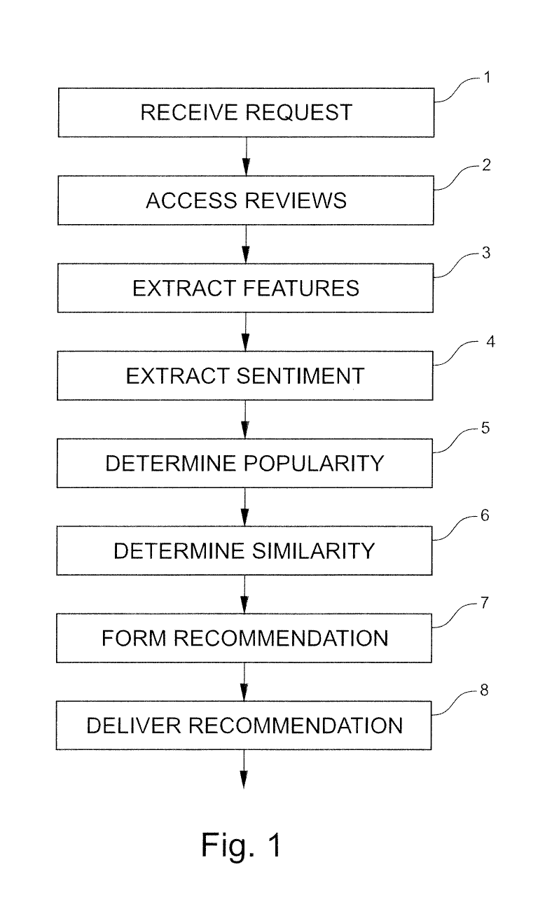

Referring to the drawings, and initially to FIGS. 1 to 9 thereof, there is illustrated a computer implemented method for recommending a commodity according to the invention, and a computer implemented system for performing this method of recommending a commodity.

The commodity may be any physical product or any service provided to a consumer. For example, a physical product may be a television, or a digital camera, or an item of clothing, or the like to be purchased by a consumer. For example, a service may be attending a movie theatre, or transportation on an aircraft flight, or hotel accommodation, or the like to be purchased by a consumer.

In this case the method comprises a sequence of eight steps as illustrated in FIG. 1. All of the steps of the method are automatically implemented by a computer system.

The computer system may be provided with a website interface to receive a request from a user for a commodity recommendation. The user wishes to obtain a recommendation for a commodity the same or similar to a first commodity Q. The computer system may receive the request in any suitable form, for example, using a keyboard, or a mouse click, or the like. In this case the request comprises a request indicator. The request indicator is associated with the first commodity Q. The request indicator serves as an input query from the user to the computer system. The request indicator may be provided in any suitable computer-readable format, for example, the request indicator may comprise a string of text.

The computer system initially receives 1 the request for the commodity recommendation from the user at the website interface. Responsive to receiving the request, the computer system accesses 2 a plurality of commodity reviews.

Each of the plurality of commodity reviews is pre-defined by a previous consumer of the commodity. Each commodity review may be pre-defined by the previous consumer of the commodity by inputting data, such as text and images, using a website interface for storage of the data at a local or a remote location. A first commodity review may include a description of the previous consumer's experience of a first commodity only. A second commodity review may include a description of the previous consumer's experience of a second commodity only, where the second commodity is different to the first commodity. Alternatively a commodity review may include a description of the previous consumer's experience of two or more different commodities in the same commodity review.

Each commodity review may include a description of features of the commodity. For example, in the case of the commodity being a television, a feature of the television may be the width of the screen. Each feature of the commodity is represented in the commodity review as a feature indicator. In this case the feature indicator comprises a string of text. For example, in the case of the commodity being a television and the feature being the width of the screen, the feature indicator is the string of text “screen width”. Because each commodity review is pre-defined by the previous consumer, each of the feature indicators is pre-defined by the previous consumer of the commodity.

Alternatively one or more of the commodity reviews may be pre-defined by a provider of the commodity. Similarly one or more of the feature indicators may be pre-defined by a provider of the commodity, for example, a manufacturer of the television or a retailer of the television.

Each commodity review may include a description of the previous consumer's sentiments in relation to the previous consumer's experience of the features of the commodity. For example, in the case of the commodity being a television and the feature being the width of the screen, a previous consumer's sentiments in relation to the previous consumer's experience of the screen width may be that the screen width was good, or too big, or adequate. Each sentiment feature of the previous consumer's in relation to the previous consumer's experience of a feature is represented in the commodity review as a sentiment indicator. In this case the sentiment indicator comprises a string of text. For example, in the case of the commodity being a television and the feature being the width of the screen and the sentiment being good, the sentiment indicator is the string of text “good”. Because each commodity review is pre-defined by the previous consumer, each of the sentiment indicators is defined by the previous consumer of the commodity.

The computer system extracts 3 one or more feature indicators from each commodity review by performing shallow natural language processing (“NLP”) of the commodity review, and the computer system extracts 4 one or more sentiment indicators from each commodity review.

The commodity reviews may be accessible by trawling from several distinct websites, for example, Amazon®, NewEgg®, etc, as opposed to a single site only. In this manner the invention sources reviews from multiple sites.

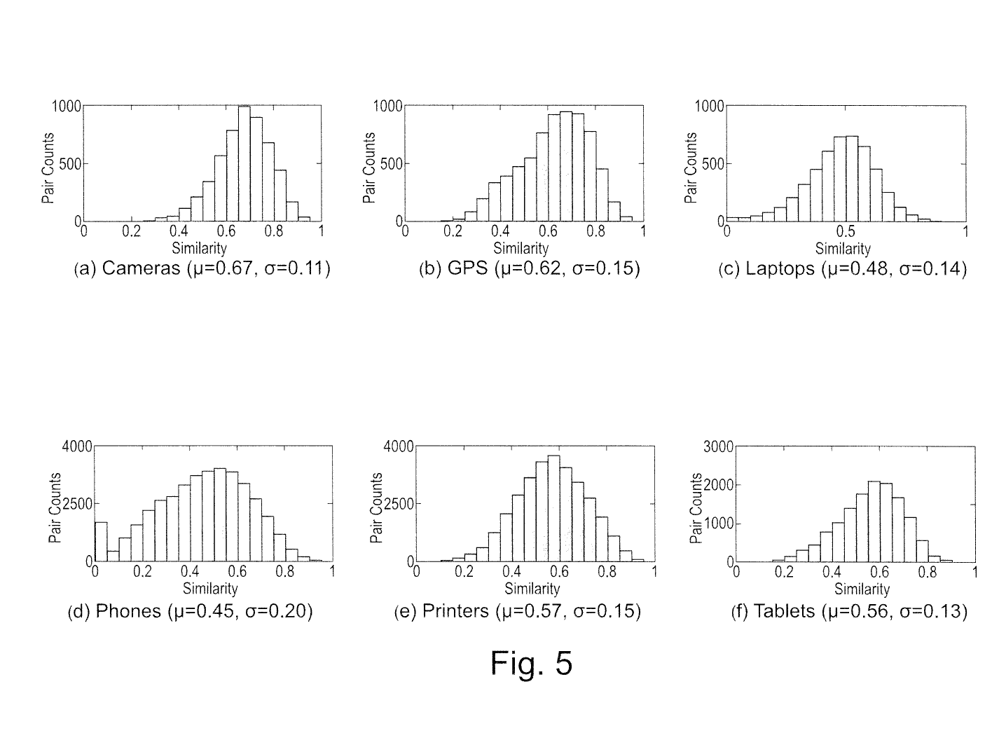

The invention mines product experiences to implement a practical technique for turning user-generated product reviews into rich, feature-based, experiential product cases. The features of these cases relate to topics that are discussed by reviewers and their aggregate opinions. The 3-step approach is summarised in FIG. 5 for a given product, P:

(1) use shallow NLP techniques to extract a set of candidate features from Reviews(P), the reviews of P;

(2) each feature, Fi, is associated with a sentiment label (positive, negative, or neutral) based on the opinion expressed in review, Rk, for P; and

(3) these topics and sentiment scores are aggregated at the product level to generate a case of features and overall sentiment scores.

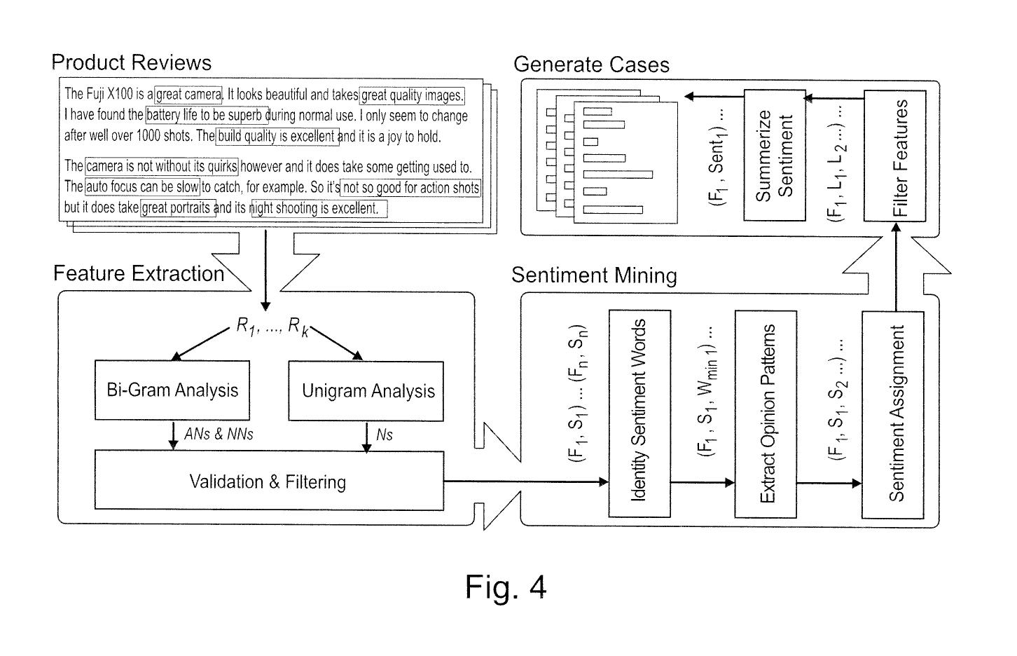

FIG. 4 illustrates extracting experiential product cases from user-generated reviews.

Considering two basic types of features—bi-gram features and single-noun features—and the invention uses a combination of shallow NLP and statistical methods to mine them. For the former the invention looks for bi-grams in reviews which conform to one of two basic part-of-speech co-location patterns:

(1) an adjective followed by a noun (AN) (e.g. wide angle);

### Or

(2) a noun followed by a noun (NN) (e.g. video mode).

These candidate features are altered to avoid including AN's that are actually opinionated single-noun features; e.g. great ash is really a single-noun feature, ash. To do this bi-grams whose adjective is a sentiment word (e.g. excellent, terrible etc.) in the sentiment lexicon are excluded.

For single-noun features the invention also extracts a candidate set, this time nouns, from the reviews but validates them by eliminating nouns that are rarely associated with sentiment words. The reason is that such nouns are unlikely to refer to product features. The invention calculates how frequently each feature co-occurs with a sentiment word in the same sentence, and retains a single-noun only if its frequency is greater than some fixed threshold (in this case 70%).

For each feature indicator extracted from the plurality of commodity reviews, the computer system determines 5 the popularity of this particular feature indicator. The popularity is determined by determining the number of commodity reviews from which this particular feature indicator is extracted. This number of commodity reviews from which this particular feature indicator is extracted is represented as a popularity indicator.

The computer system then determines 6 the similarity between a first commodity Q described in one or more of the commodity reviews and a different second commodity C described in one or more of the commodity reviews. This similarity is represented as a similarity indicator. The similarity is determined by aggregating the popularity indicator for each feature indicator of the first commodity Q and aggregating the popularity indicator for each feature indicator of the second commodity C. In this case the similarity is determined by aggregating the popularity indicator for each feature indicator of the first commodity Q and aggregating the popularity indicator for each feature indicator of the second commodity C in a cosine metric according to equation 4.

Alternatively the similarity may be determined by aggregating the popularity indicator for each feature indicator of the first commodity Q and aggregating the popularity indicator for each feature indicator of the second commodity C in a Jaccard metric, or in an overlap metric.

The invention uses the feature-based product representations to implement a content-based approach to recommendation: to retrieve and rank recommendations based on their feature similarity to a query product. The feature sentiment hints used in the invention enable recommendation in which new products can be recommended because they cover improvements over certain features of the query product. The invention provides such an alternative and a hybrid technique that allows for the flexible combination of similarity and sentiment.

In the content-based recommendation strategy, each product case is represented as a vector of features and corresponding popularity scores as per equation 2 below. As such, the value of a feature represents its frequency in reviews as a proxy for its importance. Then the invention uses the cosine metric to compute the similarity between the query product, Q, and candidate recommendation, C as per equation 4.

$$Sim ( Q , C ) = \frac{{\sum }_{{F}_{i} ∈ F ( Q ) ⋃ F ( C )}^{ } Pop ( {F}_{i} , Q ) \times Pop ( {F}_{i} , C )}{\sqrt{{\sum }_{{F}_{i} ∈ F ( Q )}^{ } {Pop ( {F}_{i} , Q )}^{2}} \times \sqrt{{\sum }_{{f}_{i} ∈ F ( C )}^{ } {Pop ( {F}_{i} , C )}^{2}}} \qquad ( 4 )$$

The computer system evaluates the sentiment indicators and evaluates the similarity indicator to form 7 a commodity recommendation. In this case the commodity recommendation is formed by combining the sentiment indicators and the similarity indicator according to equation 8.

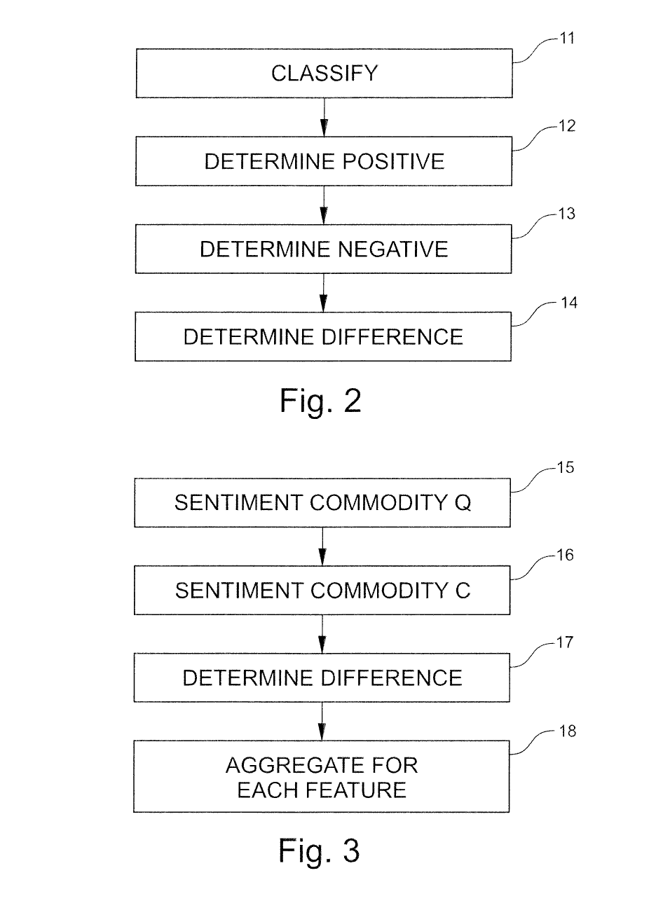

The evaluation of the sentiment indicators is illustrated in FIGS. 2 and 3. Initially for a particular feature indicator, the computer system classifies 11 each sentiment indicator associated with this particular feature indicator as being a positive sentiment indicator, a negative sentiment indicator, or a neutral sentiment indicator. The computer system determines 12 the number of positive sentiment indicators associated with this particular feature indicator, and determines 13 the number of negative sentiment indicators associated with this particular feature indicator, and determines the number of neutral sentiment indicators associated with this particular feature indicator. The computer system then determines the difference 14 between the number of positive sentiment indicators associated with this particular feature indicator and the number of negative sentiment indicators associated with this particular feature indicator. In this case the sentiment indicators are evaluated according to equation 1.

For each product P the invention has a set of features F(P)=fFl; : : : ; Fmg extracted from Reviews(P), and for each feature Fi we have a set of positive, negative, or neutral sentiment labels (L1; L2; : : : ) extracted from the particular reviews in Reviews(P) that discuss Fi. The invention only includes features in a product case if they are mentioned in at least 10% of the reviews for that product. For these features the invention calculates an overall sentiment score as shown in Equation 1 and their popularity as per Equation 2. Then each product case, Case(P), can be represented as shown in Equation 3. Note, Pos(Fi; P), Neg(Fi; P), and Neut(Fi; P) denote the number of times that feature Fi has positive, negative and neutral sentiment in the reviews for product P, respectively.

$$\begin{matrix}Sent ( {F}_{i} , P ) = \frac{Pos ( {F}_{i} P ) - Neg ( {F}_{i} , P )}{Pos ( {F}_{i} , P ) + Neg ( {F}_{i} , P ) + Neut ( {F}_{i} , P )} & ( 1 ) \\ Pop ( {F}_{i} , P ) = \frac{\vert \{ {R}_{K} ∈ Reviews ( P ) \text{:} {F}_{i} ∈ {R}_{k} \} \vert}{\vert Reviews ( P ) \vert} & ( 2 ) \\ Case ( P ) = \{ [ {F}_{i} , Sent ( {F}_{i} , P ) , Pop ( {F}_{i} , P ) ] \text{:} {F}_{i} ∈ F ( P ) \} & ( 3 )\end{matrix}$$

To calculate feature sentiment the invention uses a version of the opinion pattern mining technique for extracting opinions from unstructured product reviews. For a given feature Fi, and the corresponding review sentence Sj in review Rk, the invention determines whether there are any sentiment words in Sj. If there are not then this feature is labeled as neutral. Otherwise the invention identifies the sentiment word wmin which is closest to Fi. Next the invention identifies the part-of-speech (POS) tags for wmin, Fi and any words that occur between wmin and Fi. This POS sequence is an opinion pattern. For example, in the case of the bi-gram feature screen quality and the review sentence, “ . . . this tablet has excellent screen quality . . . ” then wmin is the word “excellent” which corresponds to an opinion pattern. After a complete pass over all features the invention computes the frequency of occurrence of all opinion patterns. A pattern is deemed to be valid if it occurs more than once. For valid patterns the invention assigns sentiment based on the sentiment of wmin and subject to whether Sj contains any negation terms within a 4-word-distance of wmin. If there are no such negation terms then the sentiment assigned to Fi in Sj is that of the sentiment word in the sentiment lexicon. Otherwise the sentiment is reversed. If an opinion pattern is deemed not to be valid (based on its frequency) then the invention assigns a neutral sentiment to each of its occurrences within the review set.

This sequence of steps 11 to 14 is repeated 15 for each feature indicator associated with the first commodity Q. This sequence of steps 11 to 14 is then performed 16 for each feature indicator associated with the second commodity C.

For a particular feature indicator, the computer system determines 17 the difference between the sentiment indicators associated with the first commodity Q and the sentiment indicators associated with the second commodity C. In this case the difference is determined according to equation 5.

This step 17 of determining the difference between the sentiment indicators may be repeated for each feature indicator in common between the first commodity Q and the second commodity C. The computer system aggregates 18 the differences for each feature indicator in common between the first commodity Q and the second commodity C. In this case the differences are aggregated according to equation 6.

Alternatively this step 17 of determining the difference between the sentiment indicators may be repeated for each feature indicator of the first commodity Q and for each feature indicator of the second commodity C. The computer system assigns a neutral sentiment indicator for each feature indicator not in common between the first commodity Q and the second commodity C. The computer system aggregates 18 the differences for each feature indicator of the first commodity Q and for each feature indicator of the second commodity C. In this case the differences are aggregated according to equation 7.

The invention uses the availability of feature sentiment to enable recommendation. The invention looks for products that offer better sentiment than the query product. The starting point for this is the better function shown as equation 5, which calculates a straightforward better score for feature Fi between query product Q and recommendation candidate C. A better score less than 0 means that the query product Q has a better sentiment score for Fi than C whereas a positive score means that C has the better sentiment score for Fi compared to Q.

$$better ( {F}_{i} , Q , C ) = \frac{Sent ( {F}_{i} , C ) - Sent ( {F}_{i} , Q )}{2} \qquad ( 5 )$$

The invention then calculates an overall better score at the product level by aggregating the individual better scores for the product features. There are two ways to do this. First in equation 6 we compute the average better scores across the features that are shared between Q and C. This approach does not account for those features that may be unique to Q or C, so called residual features.

$$B 1 ( Q , C ) = \frac{{\sum }_{{F}_{i} ∈ F ( Q ) ⋂ F ( C )}^{ } better ( {F}_{i} , Q , C )}{\vert F ( Q ) ⋂ F ( C ) \vert} \qquad ( 6 )$$

A second alternative, to deal with these residual features, is to assign non-shared features a neutral sentiment score of 0 and then compute an average better score across the union of features in Q and C as in equation 7.

$$B 2 ( Q , C ) = \frac{{\sum }_{{F}_{i} ∈ F ( Q ) ⋃ F ( C )}^{ } better ( {F}_{i} , Q , C )}{\vert F ( Q ) ⋃ F ( C ) \vert} \qquad ( 7 )$$

The above provides two alternatives for a sentiment-based approach to recommendation, which ranks product cases in decreasing order of their better score (either B1 or B2). They prioritise recommendations that enjoy more positive reviews across a range of features relative to the query product. However, these recommendations may not necessarily be very similar to the query product. What is required is a way to combine similarity and sentiment during recommendation so that the invention can prioritise products that are similar to the query product while also being more positively reviewed. The invention combines similarity and sentiment approaches by using a hybrid scoring metric such as that shown in equation 8; in this instance Sent(Q;C) can be implemented as either B1 or B2 above. Thus the invention computes an overall score for a candidate recommendation C based on a combination of C's similarity and sentiment scores with respect to Q. The relative contribution is controlled by a single parameter, w, and note that the invention normalises the sentiment scores to fall within the range 0 to 1. In what follows the invention uses this as the basic recommendation ranking approach, implementing versions that use B1 and B2 and varying w to control the relative influence of feature similarity and sentiment during recommendation.

$$Score ( Q , C ) = ( 1 - w ) \times Sim ( Q , C ) + w \times ( \frac{Sent ( Q , C ) + 1}{2} ) \qquad ( 8 )$$

After the commodity recommendation has been formed in step 7, the computer system delivers 8 the commodity recommendation to the user using the website interface. In this case the commodity recommendation comprises a recommendation indicator. The recommendation indicator is associated with the second commodity C. The recommendation indicator may be provided in any suitable computer-readable format, for example, the request indicator may comprise a string of text.

Alternatively the recommendation indicator may comprise an image.

Alternatively the method may comprise delivering an image and/or a graphical representation derived from the commodity recommendation.

The computer system may also deliver one or more of the feature indicators to the user using the website interface. The computer system may also deliver one or more of the sentiment indicators to the user using the website interface. The computer system may also deliver any of the interim results of steps 11 to 18 of evaluating the sentiment indicators or the final result of evaluating the sentiment indicators to the user using the website interface. The computer system may also deliver one or more of the popularity indicators to the user using the website interface. The computer system may also deliver the similarity indicator to the user using the website interface.

The invention thus provides explanations of the commodity recommendation. The invention provides a system that generates a “meta-review” which corrals and parses multiple customer/user product reviews to create a unified review. This meta-review gives the reader the consensus opinion from all the collated reviews about various product features discussed in reviews. The invention also explains the various choices that were made when the meta-review was being created. For example, if reviews criticize the lens of a camera it should be possible for the reader to receive information which explains the criticism, such as “12 out of the 18 reviews used to generate this meta review mention the camera lens. 9 of these 12 reviews were negative about this feature”. Moreover, the reader can be presented with example sentences from reviews which capture the majority view about the feature(s) in question. This makes the information contained within the meta-review more transparent.

### (1) Recommendation Explanation:

Given the representation of products as sets of features and associated sentiment which are mined from product reviews, it is possible to leverage this information to provide explanations to users as to why particular products are being recommended. For example, an explanation for the top-recommended product may be: “this product is recommended as it has superior lens quality and battery life etc. compared to the product you are currently examining”. All recommended products can be explained in this way, providing the user with an easy to understand rational for recommendations.

### (2) Product Comparison:

In a similar manner to the above, two products can be compared based on the sentiment associated with their shared features. The product comparison of the invention is based on features that users actually discuss in reviews (i.e. those that we automatically mined from reviews) and which are more likely to be comprehensible and informative to non-expert and consumers.

### (3) Product Summarisation:

Again, based on the representation of products as sets of mined features and associated sentiment, it is possible to use this information to create product summaries. For example, the advantages and disadvantages of a particular product can be highlighted (i.e. those features which are associated with mainly positive and negative sentiment in reviews). Moreover, controversial features (features about which sentiment is divided) can be highlighted to users.

For example, for a 13″ Retina MacBook Pro®, product with its product features, as listed by Amazon®, cover technical details such as screen-size. RAM, processor speed, and price. These are the type of features that one might expect to find in a conventional content-based recommender. Often, such features can be difficult to locate and can be technical in nature, thereby limiting recommendation opportunities and making it difficult for casual shoppers to judge the relevance of suggestions in any practical sense. However, the MacBook Pro® has more than 70 reviews which encode valuable insights into a great many of its features; from its “beautiful design” and “great video editing” capabilities to its “high price”. These features capture more detail than a handful of technical catalog features. They also encode the opinions of real users and, as such, provide an objective basis for product comparisons. The invention uses such features as the basis for a new type of experiential product recommendation, which is based on genuine user experiences. Features defined by a user when compiling such a product review represent a viable alternative to more conventional product descriptions made up of meta-data or catalog features. The invention provides a technique for automatically extracting opinionated product descriptions from user generated reviews and a flexible approach to recommendation that combines product similarity and feature sentiment.

In use, the user inputs the request 1 for a commodity recommendation for a commodity the same or similar to the first commodity Q. Responsive to receiving the request, the computer system accesses 2 the plurality of commodity reviews. The computer system extracts 3 one or more feature indicators from each commodity review, and the computer system extracts 4 one or more sentiment indicators from each commodity review. For each feature indicator extracted from the plurality of commodity reviews, the computer system determines 5 the popularity of this particular feature indicator. The computer system then determines 6 the similarity between a first commodity Q described in one or more of the commodity reviews and a different second commodity C described in one or more of the commodity reviews by aggregating the popularity indicator for each feature indicator of the first commodity Q and aggregating the popularity indicator for each feature indicator of the second commodity C in a cosine metric.

For a particular feature indicator, the computer system classifies 11 each sentiment indicator associated with this particular feature indicator as being a positive sentiment indicator, a negative sentiment indicator, or a neutral sentiment indicator. The computer system determines 12 the number of positive sentiment indicators associated with this particular feature indicator, and determines 13 the number of negative sentiment indicators associated with this particular feature indicator. The computer system then determines the difference 14 between the number of positive sentiment indicators associated with this particular feature indicator and the number of negative sentiment indicators associated with this particular feature indicator. This sequence of steps 11 to 14 is repeated 15 for each feature indicator associated with the first commodity Q. This sequence of steps 11 to 14 is then performed 16 for each feature indicator associated with the second commodity C. For a particular feature indicator, the computer system determines 17 the difference between the sentiment indicators associated with the first commodity Q and the sentiment indicators associated with the second commodity C.

This step 17 of determining the difference between the sentiment indicators may be repeated for each feature indicator in common between the first commodity Q and the second commodity C. The computer system aggregates 18 the differences for each feature indicator in common between the first commodity Q and the second commodity C. Alternatively this step 17 of determining the difference between the sentiment indicators may be repeated for each feature indicator of the first commodity Q and for each feature indicator of the second commodity C. The computer system assigns a neutral sentiment indicator for each feature indicator not in common between the first commodity Q and the second commodity C. The computer system aggregates 18 the differences for each feature indicator of the first commodity Q and for each feature indicator of the second commodity C.

The computer system evaluates the sentiment indicators and evaluates the similarity indicator to form 7 the commodity recommendation. After the commodity recommendation has been formed in step 7, the computer system delivers 8 the commodity recommendation for the second commodity C to the user using the website interface.

### Example 1

Thus far we have presented two core technical contributions: (1) a technique for extracting feature-based product descriptions from user-generated reviews; and (2) an approach to generating product recommendations that leverages a combination of feature similarity and review sentiment. We now describe the results of a comprehensive experiment designed to evaluate different aspects of both of these contributions using a multi-domain product dataset from Amazon®. In particular, we will focus on evaluating the type of product descriptions that can be extracted, in terms of the variety of features and sentiment information, as well as assessing their suitability for recommendation based on similarity and sentiment scores. Importantly this will include an analysis of the benefits of using these approaches in a practical recommendation setting, and by comparison to Amazon's® own recommendations.

Datasets

The data for this experiment was extracted from Amazon.com® during October 2012. We focused on 6 different product categories: Digital Cameras, GPS Devices, Laptops, Phones, Printers, and Tablets. For each product, we extracted review texts and helpfulness information, and the top n recommendations for ‘related’ products as suggested by Amazon®. In our analysis, we only considered products with at least 10 reviews; see Table 1 for dataset statistics.

TABLE 1
Dataset statistics.

| Category | #Reviews | #Products | μ_{features} | σ_{features} |
|---|---|---|---|---|
| Cameras | 9,355 | 103 | 30.77 | 12.29 |
| GPS | 12,115 | 119 | 24.32 | 10.82 |
| Laptops | 12,431 | 314 | 28.60 | 15.21 |
| Phones | 14,860 | 257 | 9.35 | 5.44 |
| Printers | 24,369 | 233 | 16.89 | 7.60 |
| Tablets | 17,936 | 166 | 26.15 | 10.48 |

Mining Rich Product Descriptions

The success of the recommendation approach developed in this work depends critically on our ability to translate user-generated reviews into useful product cases; in the sense that they are rich enough, in terms of their features, to form the basis of recommendation.

Product Similarity

The last two columns in Table 1 show the mean and standard deviation of the number of features that are extracted across the 6 product domains. It should be clear that we can expect to generate reasonably feature-rich cases from our review mining approach as 10-30 features are extracted per product case on average. However, this is of limited use if the variance in similarity between products in each category is low. FIG. 5 shows histograms for the similarity values between all pairs of products for each of the 6 Amazon® domains. Once again the results bode well because they show a wide range of possible similarity values, rather than a narrow range of similarity which may suggest limitations in the expressiveness of the extracted product representations.

FIG. 5 shows Product similarity histograms.

Sentiment Heatmaps

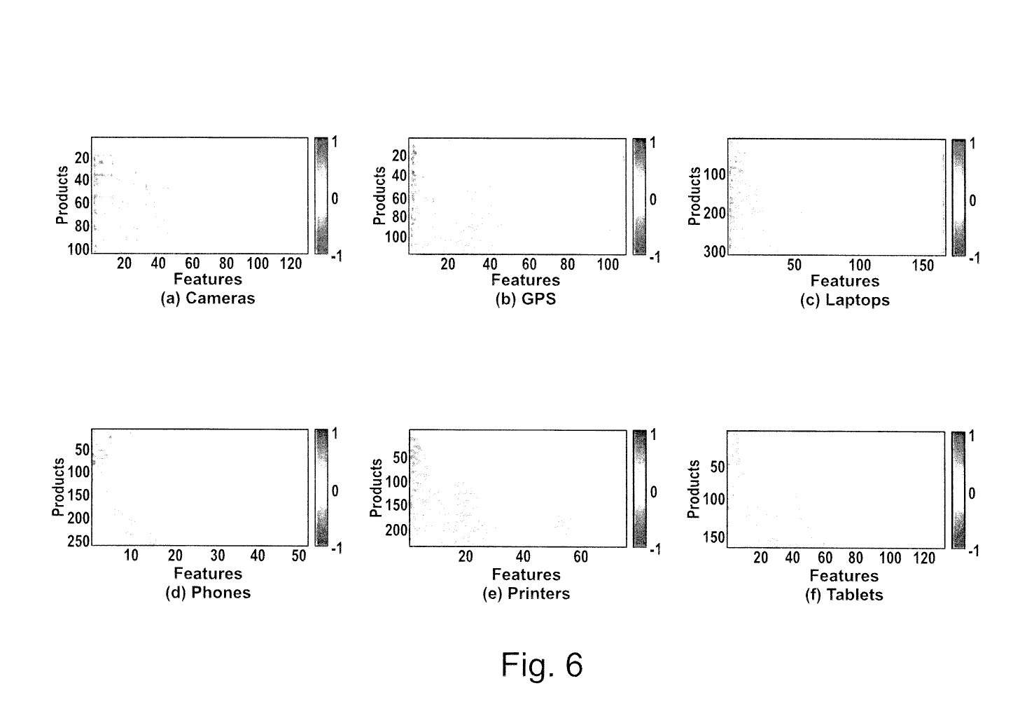

It is also interesting to look at the different types of sentiment expressed for different features in the product categories. FIG. 6 shows sentiment heatmaps for each of the 6 product categories. Rows correspond to product cases and columns to their features. The sentiment of a particular feature is indicated by colour, from red (strong negative sentiment) to green (strong positive sentiment); missing features are shown in grey. Both the feature columns and product rows are sorted by average sentiment. There are a number of observations to make. First, because of the ordering of the features we can clearly see that features with the highest (leftmost) and lowest (rightmost) sentiment scores also tend to elicit the most opinions from reviewers; the leftmost and rightmost regions of the heatmaps are the most densely populated. By and large there is a strong review bias towards positive or neutral opinions; there are far more green and yellow cells than red. Some features are almost universally liked or disliked. For example, for Laptops the single most liked feature is price with screen and battery life also featuring highly. In contrast, features such as wifi and fan noise are among the most universally disliked Laptop features. Across the product domains, price is generally the most liked feature, suggesting perhaps that modern consumer electronics pricing models are a good fit to consumer expectations, at least currently.

FIG. 6 shows Product feature sentiment heatmaps.

Recommendation Performance

To evaluate our recommendation approach we use a standard leave-one-out approach, comparing our recommendations, for each query product Q, to those produced by Amazon®; as discussed previously we scraped Amazon's® recommendations during our dataset collection phase. Specifically, for each query product Q in a given domain we generate a set of n=5 ranked recommendations using Equation 8 instantiated with B1 and B2; we do this for each value of w from 0 to 1 in steps of 0.1. This produces 22 recommendation lists, for each Q, 11 for each of B 1 and B2, which we compare to Amazon's® own recommendations for Q.

Recommendation Precision

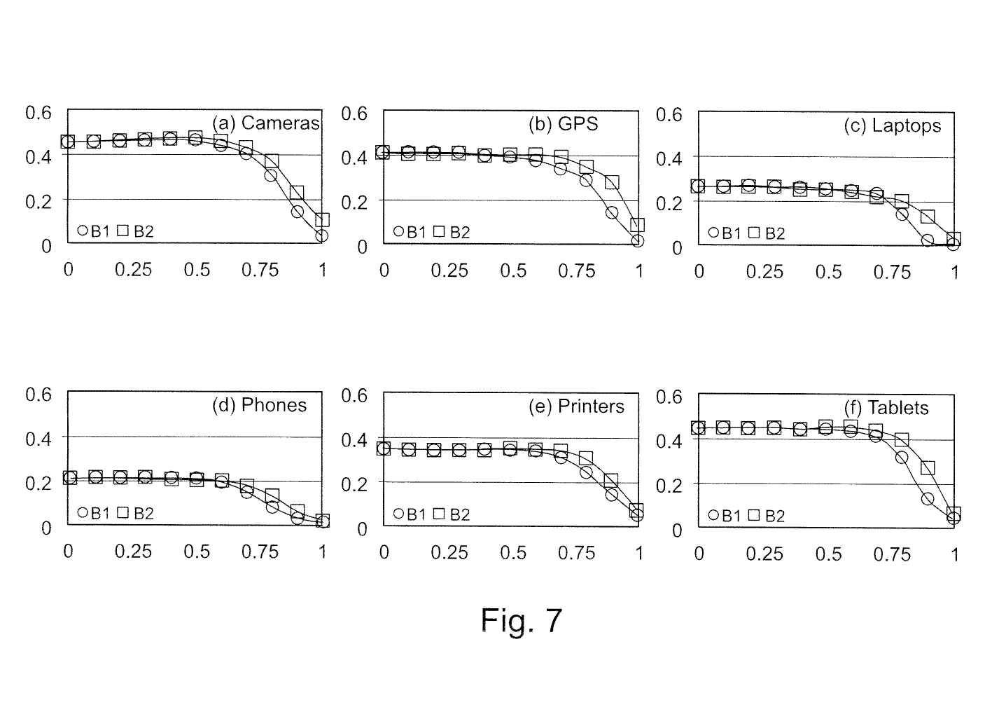

We calculate a standard precision metric to compare our recommendations to Amazon's®, by calculating the percentage of our recommendations that are contained in Amazon's® recommendation lists. FIG. 7 presents these results averaged over all products for each of the six product domains as we vary w. We can see that lower values of w (<0.5), where feature similarity plays a major ranking role, producing recommendation lists that include more Amazon® recommendations compared to higher values of w (>0.5) where feature sentiment plays the major role. For example, in the Camera domain lower values of w lead to stable precision scores of 0.4 (0.5 but precision falls quickly for w>0:7. This basic pattern is repeated across all six product domain, albeit with different absolute precision scores. The fact that precision is reasonably high for low values of w suggests that our similarity measure based on extracted features is proving to be useful from a recommendation standpoint as it enables us to suggest some of the same products as Amazon's® own ratings-based recommender. As w increases, and feature sentiment begins to play a more influential role in recommendation ranking, both B1 and B2 start to prefer recommendation candidates that are not present in Amazon's® recommendations and so precision falls. Of course, as a practical matter, our objective is not necessarily to maximise this precision metric. It serves only as a superficial guide to recommendation quality relative to the Amazon® baseline. But the real question is whether there is any evidence that the non-Amazon® recommendations made by B1 and B2 are in any way superior to the Amazon® recommendations, especially as when w increases, non-Amazon® recommendations come to dominate.

FIG. 7 shows Precision (y-axis) versus w (x-axis) for each product domain; B1 and B2 are presented as circles and squares on the line graphs, respectively.

Ratings Benefit

As an alternative to conventional precision metrics, we propose to use Amazon's® overall product ratings as an independent objective measure of product quality. Specifically, we compute a relative benefit metric to compare two sets of recommendations based on their ratings, as per Equation 9; e.g. a relative benefit of 0.15 means that our recommendations R enjoy an average rating score that is 15% higher than those produced by Amazon® (A).

$$Benefit ( R , A ) = \frac{\overline{Rating} ( R ) - \overline{Rating} ( A )}{\overline{Rating} ( A )} \qquad ( 9 )$$

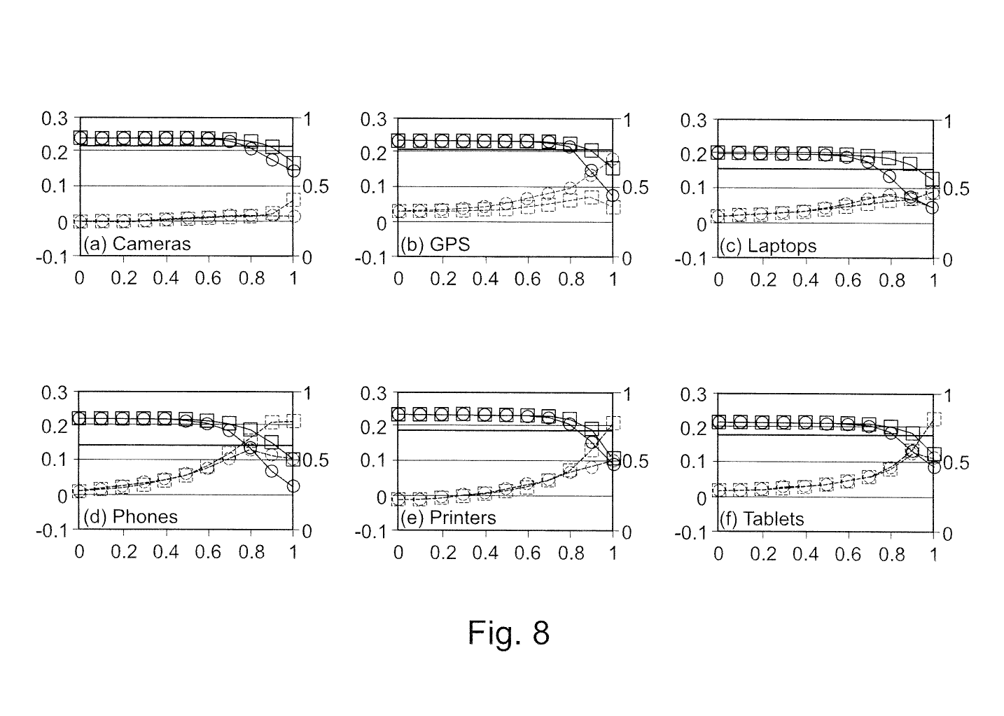

We also compute the average similarity between our recommendations and the current query product, using our mined feature representations; we refer to this as the query product similarity. This allows us to evaluate whether our techniques are producing recommendations that continue to be related to the query product—there is little benefit to recommending highly rated products that bear little or no resemblance to the type of product the user is looking for and, as we shall see it also provides a basis for a more direct comparison to Amazon's® own recommendations. The results of this analysis are presented for the 6 product domains in FIG. 8 (a-f) for B1 and B2 when recommending n=5 products. In each graph we show the benefit scores (left y-axis) for B1 and B2 (dashed lines) for varying values of w (x-axis), along with the corresponding query product similarity values (right y-axis, solid lines). We also show the average similarity between the query product and the Amazon® recommendations, which is obviously unaffected by w and so appears as a solid horizontal line in each chart. These results allow us to examine the performance of a variety of different recommendation strategies based on the combination of mined feature similarity and user sentiment.

FIG. 8 shows Ratings benefit (left y-axis and dashed lines) and query similarity (right y-axis and solid lines) versus w (x-axis); B1 and B2 are presented as circles and squares on the line graphs respectively and the Amazon® query similarity is shown as a solid horizontal line.

Contrasting Sentiment and Similarity

To begin with we will look at the extremes where w=0 and w=1. At w=0 both B1 and B2 techniques are equivalent to a pure similarity-based approach to recommendation (i.e. using cosine as per Equation 4), because sentiment is not contributing to the overall recommendation score. For this configuration there is little or no ratings benefit—the recommendations produced have very similar average ratings scores to those produced by Amazon®—although both B1 and B2 tend to produce recommendations that are more similar to the query product, in terms of the features mentioned in reviews, than Amazon's® own recommendations. For example, in the Phones dataset (FIG. 8(d)) at w=0 we can see that B1 and B2 have a ratings benefit of approximately 0 and a query product similarity of just under 0.8 compared to approximately 0.6 for Amazon's® comparable recommendations. Another interesting configuration is at w=1, which rejects an approach to recommendation that is based solely on sentiment and without any similarity component. In this configuration we can see a range of maximum positive ratings benefits (from 0.06 to 0.23) across all 6 product domains. Further, B2 generally outperforms B1 (at this w=1 setting). For example, looking again at the Phones dataset (FIG. 8(d)), at w=1 we see a ratings benefit of 0.21 for B2. In other words the products recommended by B2 enjoyed ratings that were approximately 21% higher than those products recommended by Amazon®; it is worth noting that this represents on average an increase of almost one rating-scale point for Amazon's®, 5-point scale. However, these ratings benefits are tempered by a drop in query product similarity. At w=1, query product similarity falls to between 0.31 and 0.67, and typically below the query product similarity of the average Amazon® recommendations (approximately 0.6-0.8 across the 6 product domains). Based on the similarity analysis from FIG. 5 we can calibrate the extent of this drop by noting that, for B1 in particular, it often leads to recommendations whose average similarity to the query product is less than the average similarity between any random pair of products in a given domain. In other words there is a tradeoff between these ratings benefits and query product similarity and a likelihood that the better rated recommendations suggested by our approaches may no longer be sufficiently similar to the query product to meet the user's product needs or preferences.

Combining Similarity and Sentiment

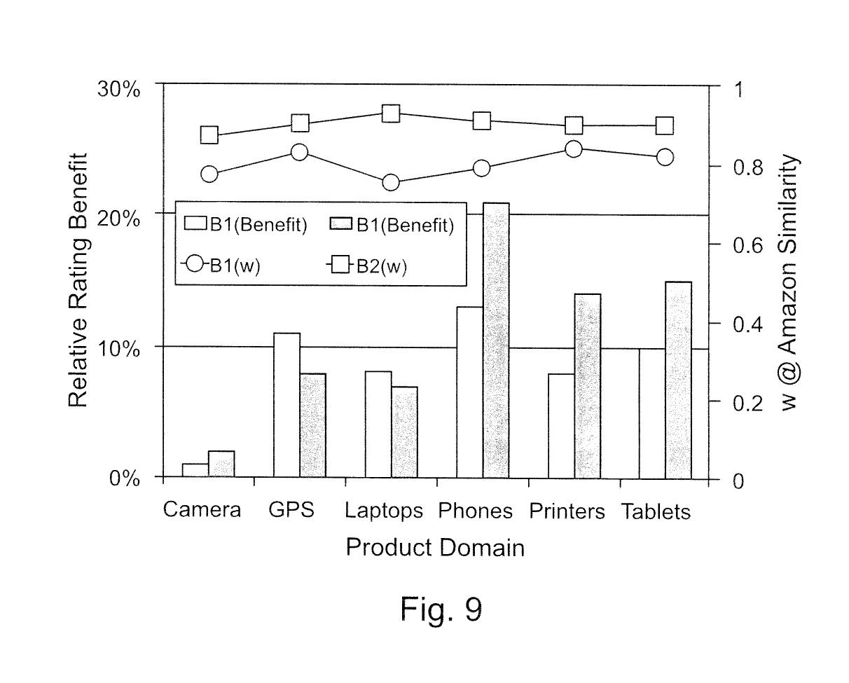

By varying the value of w we can explore different combinations of similarity and sentiment during recommendation to better understand this tradeoff between query product similarity and ratings benefit. For example, as w increases we can see a gradual increase in ratings benefit for both B1 and B2, with B2 generally outperforming B1, especially for larger values of w. In some domains (e.g. Cameras and Laptops) the ratings benefit increase is more modest (<0:1) whereas a more significant ratings benefit is observed for GPS; Phones; Printers, and Tablets. The slope of these ratings benefit curves and the maximum benefit achieved is influenced by the nature of the ratings-space in the different domains. For example, Cameras and Laptops have the highest average ratings and lowest standard deviations of ratings across the 6 domains. This suggests that there is less room for ratings improvement during recommendation. In contrast, Phones and Tablets have among the lowest average ratings and highest standard deviations and thus enjoy much greater opportunities for improved ratings. As expected query product similarity is also influenced by w. For w<0:7 we see little change in query product similarity. But for w>0:7 there is a drop in query product similarity as sentiment tends to dominate during recommendation ranking. This query product similarity profile is remarkably consistent across all product domains and in all cases B2 better preserves query product similarity compared to B1. Overall then we find that B2 tends to offer better ratings benefits and query product similarity than B1 but it is still difficult to calibrate these differences or their relationship to the Amazon® baseline as w varies. We need a fixed point of reference for the purpose of a like-for-like comparison. To do this we compare our techniques by fixing w at the point at which the query product similarity curve intersects with the Amazon® query product similarity level and then reading the corresponding ratings benefits for B1 and B2. This is an interesting reference point because it allows us to look at the ratings benefit offered by B1 and B2 while delivering recommendations that have the same query product similarity as the baseline Amazon® recommendations. For example, as shown in FIG. 8(e), for Printers the query product similarity of B1 and B2 crossed that of Amazon® at w values of 0.83 and 0.9, respectively. And at these w values they deliver ratings benefits of 8% and 14%, respectively. In other words our sentiment-based techniques are capable of delivering recommendations that are as similar to the query product as Amazon's® but with a better average rating. In FIG. 9 we summarise these ratings benefits (bars) and the corresponding w values (lines) for B1 and B2. These results clarify the positive ratings benefits that are available using our sentiment-based recommendation techniques without compromising query product similarity. For Tablets. Printers, and Phones there are very significant ratings benefits especially for B2 (>13%). B2 also beats B1 for the Camera domain but the absolute ratings benefit is much smaller (<3%) due to the nature of the ratings space in this domain; specifically, there is little variation in camera ratings compared to other domains. In GPS we see that B1 outperforms B2, but in a relatively minor way, suggesting that in this domain the sentiment associated with the residual (non-shared) features is not playing a significant role. It is also interesting to note the consistency of the w values at which the query product similarity of the sentiment-based recommendations matches that of the Amazon® recommendations, particularly for strategy B2 (0.87{0.93). As a practical matter this suggests that a w of about 0.9 will be sufficient to deliver recommendations that balance query product similarity with significant ratings benefits, thereby avoiding the need for domain-specific calibration.

FIG. 9 shows Summary ratings benefits at Amazon® baseline query product similarity.

Summary Findings

Our aim in this evaluation has been twofold: (1) to assess the quality of the product cases that are mined solely from product reviews; and (2) to evaluate the effectiveness of using these cases, and a combination of similarity and sentiment, during recommendation. Regarding (1), it is clear that the product cases generated are feature rich with patterns of similar features extracted across many products. As to the quality of these features, the fact that they can be used as the basis for useful recommendations is a strong signal that they reflect meaningful product attributes; recommendations based solely on similarity share a strong overlap with those produced by Amazon®, for example. More specifically, regarding (2) we have demonstrated that by combining feature similarity and sentiment we can generate recommendations that are comparable to those produced by Amazon® (with respect to similarity) but enjoy higher overall user ratings, a strong independent measure of recommendation quality.

The invention provides an approach to sentiment-based recommendation (B2) and the hybrid approach for combining similarity and sentiment during recommendation.

The invention uses user-generated product reviews to provide a rich source of recommendation raw material for use as the basis for recommendation. The invention provides an approach to mining product descriptions from raw review texts and using this information to drive a recommendation technique that combines aspects of product similarity and feature sentiment. The invention has benefits in terms of recommendation quality, by combining similarity and sentiment information, compared to a suitable ground-truth (Amazon's® own recommendations). Importantly, these recommendations have been produced without the need for large-scale transaction/ratings data (cf. collaborative filtering approaches) or structured product knowledge or metadata (cf. conventional content-based approaches).

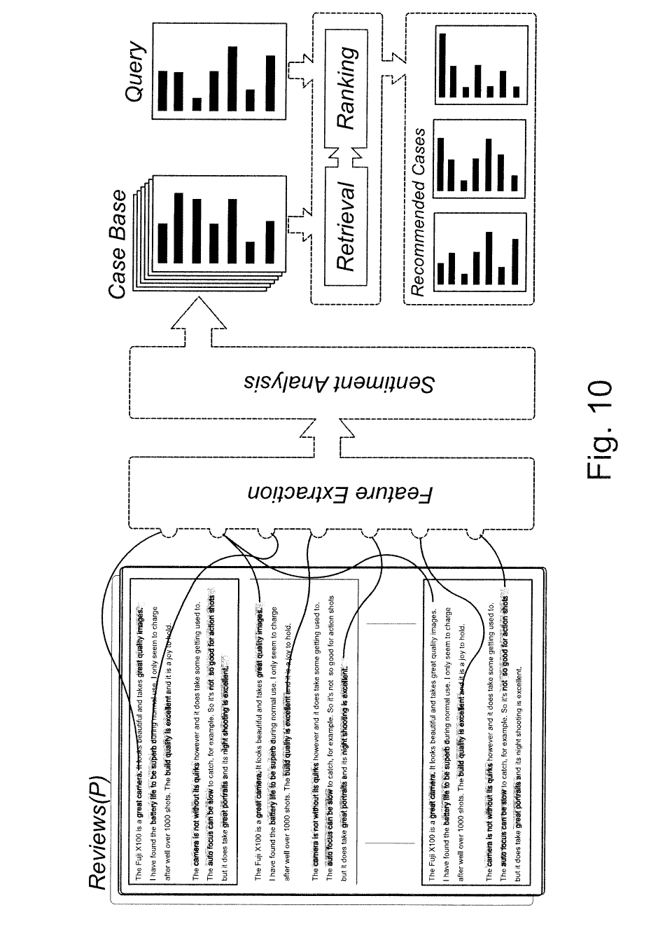

In FIGS. 10 to 14 there is illustrated another computer implemented method for recommending a commodity according to the invention, which is similar to the computer implemented method of FIGS. 1 to 9, and similar elements in FIGS. 10 to 14 are assigned the same reference numerals.

In this case, the opinionated product recommendation is a case-based product recommendation focused on generating rich product descriptions for use in a recommendation context by mining user-generated reviews. This is in contrast to conventional case-based approaches which tend to rely on case descriptions that are based on available meta-data or catalog descriptions. By mining user-generated reviews we can produce product descriptions that reflect the opinions of real users and combine notions of similarity and opinion polarity (sentiment) during the recommendation process.

The invention harnesses user-generated product reviews as a source of product information for use in novel approach to case-based recommendation, one that does rely on the experiences of users, as expressed through the opinions of real users in the reviews that they write. As a result, products can be recommended based on a combination of feature similarity and opinion polarity (or sentiment). So, for example, a traveller looking for accommodation options with a business centre can receive recommendations for hotels, not just with business centres or related services (similarity), but for hotels that have excellent business centres (sentiment). In this embodiment the invention uses user-generated reviews as a source of description information, and incorporates existing meta-data when it is available. Consequently we describe two variations on our opinionated recommendation approach. First, instead of sourcing features exclusive from user reviews, we use existing meta-data features, where available, as seed features, and look to the user reviews as a source of frequency and sentiment information. Second, we implement a hybrid approach that uses meta-data features in addition to those that can be mined from user reviews.

The cases that are produced from reviews are experiential: they are formed from the product features that users discuss in their reviews and these features are linked to the opinions of these users.

Mining Experiential Product Cases

A summary of the overall approach is presented in FIG. 10, including how we mine experiential cases and how we generate recommendations. There are 4 basic steps: (1) identifying useful product features; (2) associating these features with sentiment information based on the content of user-generated reviews; (3) aggregating features and sentiment to produce experiential cases; and (4) the retrieval and ranking of cases for recommendation given a target query.

FIG. 10 shows an overview of the experiential product recommendation architecture.

Identifying Review Features

We consider two ways to identify product features. First, we apply the technique to automatically extract features from reviews. Second, we look to product meta-data as an external source of features (i.e. external to product reviews) which can then be identified within reviews for the purpose of frequency and sentiment calculation.

Mining Product Features from Review Text

Briefly, the approach considers bi-gram features and single-noun features and uses a combination of shallow NLP and statistical methods to mine them. For example, bi-grams in reviews which conform to one of two basic part-of-speech co-location patterns are considered—an adjective followed by a noun (AN) or a noun followed by a noun (NN)—excluding bi-grams whose adjective is a sentiment word (e.g. excellent, terrible etc.) in the sentiment lexicon. Separately, single-noun features are validated by eliminating nouns that are rarely associated with sentiment words in reviews, since such nouns are unlikely to refer to product features; we will refer to features that are identified in this way as review features or RF.

Using Meta-Data as Product Features

One of the limitations of the above approach is that it can generate some unusual features that are unlikely to matter in any meaningful way during product recommendation; sometimes reviews wander off topic, for example, or address rarely relevant, or downright incorrect, aspects of a product. If this was to occur frequently, then recommendation effectiveness could be compromised. Thus, we also consider available meta-data as an original source of features that matter. For example, in the case of the TripAdvisor® data that we use in this example, the hotels themselves are accompanied by meta-data in the form of an edited set of amenities (for example, spa, swimming pool, business centre, etc.) that are available at the hotel. These amenities can serve as product features in their own right and are used as such in this alternative approach. We will refer to features that are identified in this manner as amenity features or AF.

Evaluating Feature Sentiment

For each feature (whether RF or AF in origin) we evaluate its sentiment based on the sentence containing the feature within a given review. We use a modified version of the opinion pattern mining technique for extracting opinions from unstructured product reviews. For a given feature Fi and corresponding review sentence Sj from review Rk, we determine whether there are any sentiment words in Sj. If there are not, then this feature is marked as neutral from a sentiment perspective. If there are sentiment words then we identify the word wmin which has the minimum word-distance to Fi. Next we determine the part-of-speech (POS) tags for wmin, Fi and any words that occur between wmin and Fi. The POS sequence corresponds to an opinion pattern. For example, in the case of the bi-gram feature noise reduction and the review sentence, “ . . . this camera has great noise reduction . . . ” then wmin is the word “great” which corresponds to an opinion pattern. After a complete pass of all features over all reviews, we can compute the frequency of all opinion patterns that have been recorded. A pattern is deemed to be valid (from the perspective of our ability to assign sentiment) if it occurs more than the average number of times. For valid patterns we assign sentiment to Fi based on the sentiment of wmin and subject to whether Sj contains any negation terms within a 4-word-distance of wmin. If there are no such negation terms then the sentiment assigned to Fi in Sj is that of the sentiment word in the sentiment lexicon; otherwise this sentiment is reversed. If an opinion pattern is deemed not to be valid (based on its frequency), then we assign a neutral sentiment to each of its occurrences within the review set.

Generating Experiential Cases

For each product P we have a set of features F(P)=Fl; : : : ; Fmg that have been either identified from the meta-data associated with P or that have been discussed in the various reviews of P, Reviews(P). And for each feature Fi we can compute various properties including the fraction of reviews it appears in (its popularity, see Equation 1 below) and the degree to which reviews mention it in a positive, neutral, or negative light (its sentiment, see Equation 2 below, where Pos(Fi; P), Neg(Fi; P), and Neut(Fi; P) denote the number of times that feature Fi has positive, negative and neutral sentiment in the reviews for product P, respectively). Thus, each product can be represented as a product case, Case(P), which aggregates product features, popularity and sentiment data as in Equation 3 below.

$$\begin{matrix}Pop ( {F}_{i} , P ) = \frac{\vert \{ {R}_{K} ∈ Reviews ( P ) \text{:} {F}_{i} ∈ {R}_{k} \} \vert}{\vert Reviews ( P ) \vert} & ( 1 ) \\ Sent ( {F}_{i} , P ) = \frac{Pos ( {F}_{i} P ) - Neg ( {F}_{i} , P )}{Pos ( {F}_{i} , P ) + Neg ( {F}_{i} , P ) + Neut ( {F}_{i} , P )} & ( 2 ) \\ Case ( P ) = \{ [ {F}_{i} , Sent ( {F}_{i} , P ) , Pop ( {F}_{i} , P ) ] \text{:} {F}_{i} ∈ F ( P ) \} & ( 3 )\end{matrix}$$

Recommending Products

Unlike traditional content-based recommendenrs, which tend to rely exclusively on similarity in order to rank products with respect to some user profile or query, the above approach accommodates the use of feature sentiment, as well as feature similarity, during recommendation. Briefly, a candidate recommendation product C can be scored against a query product Q according to a weighted combination of similarity and sentiment as per Equation 4 below. Sim(Q;C) is a traditional similarity metric such as cosine similarity, producing a value between 0 and 1, while Sent(Q;C) is a sentiment metric producing a value between −1 (negative sentiment) and +1 (positive sentiment).

$$Score ( Q , C ) = ( 1 - w ) \times Sim ( Q , C ) + w \times ( \frac{Sent ( Q , C ) + 1}{2} ) \qquad ( 4 )$$

Similarity Assessment

For the purpose of similarity assessment we use a standard cosine similarity metric based on feature popularity scores as per Equation 5 below; this is inline with standard approaches to content-based similarity.

$$Sim ( Q , C ) = \frac{{\sum }_{{F}_{i} ∈ F ( Q ) ⋃ F ( C )}^{ } Pop ( {F}_{i} , Q ) \times Pop ( {F}_{i} , C )}{\sqrt{{\sum }_{{F}_{i} ∈ F ( Q )}^{ } {Pop ( {F}_{i} , Q )}^{2}} \times \sqrt{{\sum }_{{f}_{i} ∈ F ( C )}^{ } {Pop ( {F}_{i} , C )}^{2}}} \qquad ( 5 )$$

Sentiment Assessment

As mentioned earlier, sentiment information is unusual in a recommendation context but its availability offers a second way to compare products, based on a feature-by-feature sentiment comparison as per Equation 6 below. We can say that Fi is better in C than Q if Fi in C has a higher sentiment score than it does in Q.

$$better ( {F}_{i} , Q , C ) = \frac{Sent ( {F}_{i} , C ) - Sent ( {F}_{i} , Q )}{2}$$

We can then calculate an overall better score at the product level by aggregating the individual better scores for the product features. We can do this in one of two ways as follows.

The first approach, which we shall refer to as B1, calculates an average better score across the shared features of Q and C as per Equation 7 below. A potential shortcoming of this approach is that it remains silent about those features which are not common to Q and C, the so-called residual features.

$$B 1 ( Q , C ) = \frac{{\sum }_{{F}_{i} ∈ F ( Q ) ⋂ F ( C )}^{ } better ( {F}_{i} , Q , C )}{\vert F ( Q ) ⋂ F ( C ) \vert} \qquad ( 7 )$$

The second approach, which we shall refer to as B2, computes the average better scores across the union of features of Q and C, assigning non-shared features a neutral sentiment score of 0; see Equation 8 below. Unlike B1, this second approach does give due consideration to the residual features in the query and candidate cases. Whether or not these residual features play a significant role remains to be seen and we will return to this question as part of the evaluation later below.

$$B 2 ( Q , C ) = \frac{{\sum }_{{F}_{i} ∈ F ( Q ) ⋃ F ( C )}^{ } better ( {F}_{i} , Q , C )}{\vert F ( Q ) ⋃ F ( C ) \vert} \qquad ( 8 )$$

Note that in Equation 4, Sent(Q;C) is set to either B1 or B2 depending on the particular recommender system variation under evaluation.

### Example 2

In this Example, we extend Example 1 in two important ways. First, we expand the evaluation considerably to cover a large set of TripAdvisor® hotel reviews, covering more than a hundred thousand reviews across thousands of hotels in 6 international cities. The importance of this is not just to evaluate a larger set of reviews and products, but also to look at reviews that have written for very different purposes (travel versus consumer electronics). The second way that we add to Example 1 is to consider the new AF variation described above as an alternative way to source product features (from meta-data); indeed, we also consider a hybrid RF-AF approach as a third algorithmic variation.

Datasets

The data for this experiment was sourced from TripAdvisor® during September 2013. We focused on 6 different cities across Europe, Asia, and the US. We extracted 148,704 reviews across 1,701 hotels. This data is summarised in Table 2, where we show the total number of reviews per city (#Reviews), the number of hotels per city (#Hotels), as well as including statistics (mean and standard deviation) on the number of amenities per hotel (A), the number of amenity features extracted from reviews per hotel (AF), and the number of review features extracted from the reviews per hotel (without seeding with amenitiesXRF). We can immediately see that using the AF technique to identify features produces much smaller feature-sets for cases than using the RF approach, owing to the limited amount of amenity meta-data availability for each hotel.

TABLE 2
Dataset statistics.

| City | #Reviews | #Hotels | μ(σ)_{A} | μ(σ)_{AF} | μ(σ)_{RF} |
|---|---|---|---|---|---|
| Dublin | 13,019 | 138 | 5.7 (2.6) | 4.1 (1.0) | 30.2 (1.6) |
| New York | 31,881 | 337 | 6.1 (2.5) | 4.0 (1.4) | 32.9 (4.8) |
| Singapore | 14,576 | 186 | 5.7 (3.4) | 3.7 (1.5) | 28.8 (6.2) |
| London | 62,632 | 717 | 4.5 (2.7) | 3.9 (1.2) | 31.8 (5.5) |
| Chicago | 11,091 | 125 | 7.6 (2.2) | 4.4 (1.3) | 28.6 (5.0) |
| Hong Kong | 15,505 | 198 | 6.2 (3.0) | 4.1 (1.6) | 33.8 (6.1) |

### Example 2

### Methodology

We adopt a standard leave-one-out approach to recommendation. For each city dataset, we treat each hotel in turn as a query Q and generate a set of top-5 recommendations according to Equation 4 using different values of w (0 to 1 in increments of 0.1) in order to test the impact of different combinations of similarity and sentiment. We do this for hotel cases that are based on amenity features and review features to produce a set of recommendations that derive from amenity features AF and a set that derive from review features RF. We also implement a hybrid approach (denoted AF-RF) that combines AF and RF by simply combining the features identified by AF and RF into a single case structure. Finally, we also implement the B1 and B2 variations when it comes to computing Sent(Q;C) in Equation 4. This provides a total of 6 difference algorithmic variants for generating recommendations. To evaluate the resulting recommendation lists we compare our recommendations to those produced natively by TripAdvisor® (TA) and we calculate two comparison metrics. First, we calculate the average query similarity between each set of recommendations (AF, RF, AF-RF and TA) and Q. To do this we use a Jaccard similarity metric based on an expanded set of hotel features that is made up of the hotel amenities plus hotel cost, star rating, and size (number of rooms). Query similarity indicates how similar recommendations are to the query case and, in particular, whether there is any difference in similarity between those recommendations generated by our approaches and those produced by TA. The second comparison metric is the average ratings benefit. This compares two sets of recommendations based on their overall TripAdvisor® user ratings (see Equation 9 below). We calculate a ratings benefit for each of our 6 recommendation lists (denoted by R in Equation 9 below) compared to the recommendations produced by TA; a ratings benefit of 0.1 means that our recommendation list enjoys an average rating score that is 10% higher than those produced by the default TripAdvisor® approach (TA).

$$RatingsBenefit ( R , TA ) = \frac{\overline{Rating} ( R ) - \overline{Rating} ( TA )}{\overline{Rating} ( TA )} \qquad ( 9 )$$

Experience Case Mining

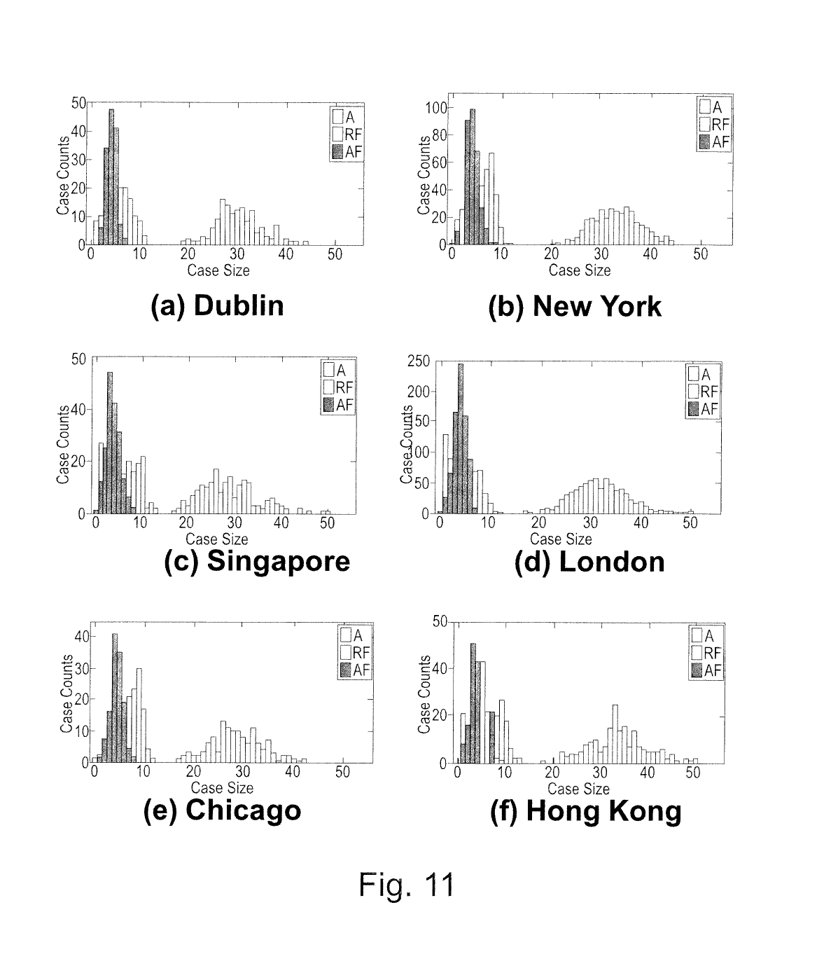

To begin with, it is worth gaining an understanding of the extent to which the AF and RF approaches are able to generate rich experiential case descriptions, in terms of the number of features that can be extracted on a product-by-product basis. To this end FIG. 11 presents features histograms showing the number of cases with different numbers of amenity features (AF) and review features (RF) as extracted from reviews, and the number of amenities (A) available for each hotel as sourced from TripAdvisor®.

As expected there is a significant different between the number of amenity features and the number of review features extracted. Clearly, cases that are based on review features enjoy much richer descriptions than those that rely only on amenity features. Moreover, it can be seen that, on average, only 4 of the 6 amenity features associated with hotels are extracted from reviews using the AF approach, which further highlights the limitations of this approach from a case representation perspective.

FIG. 11 shows the hotel case size histograms.

Recommendation Results

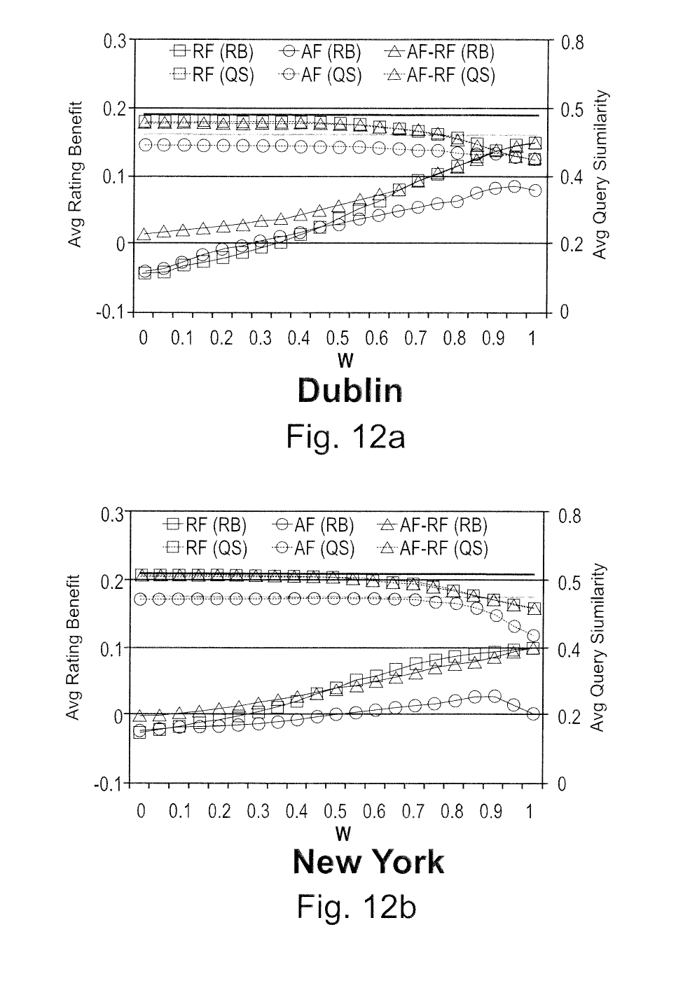

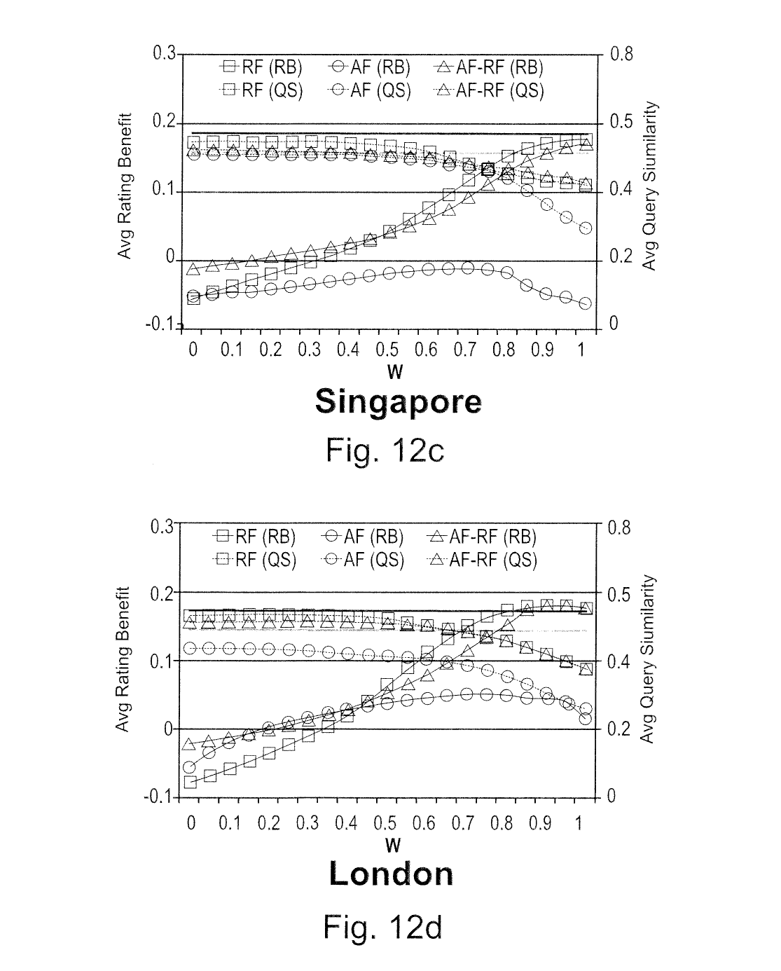

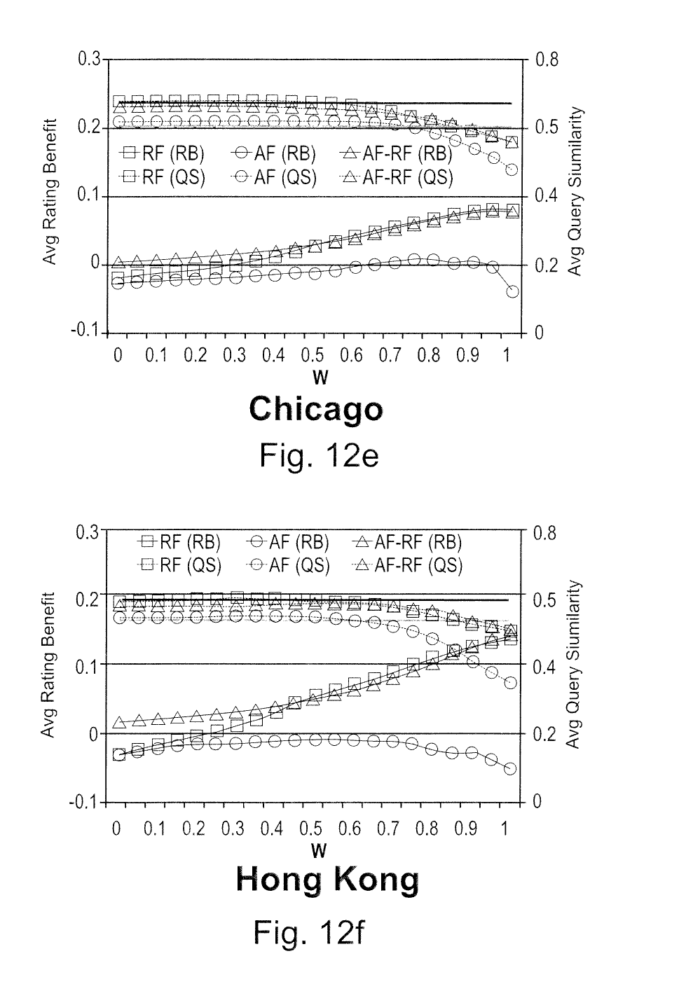

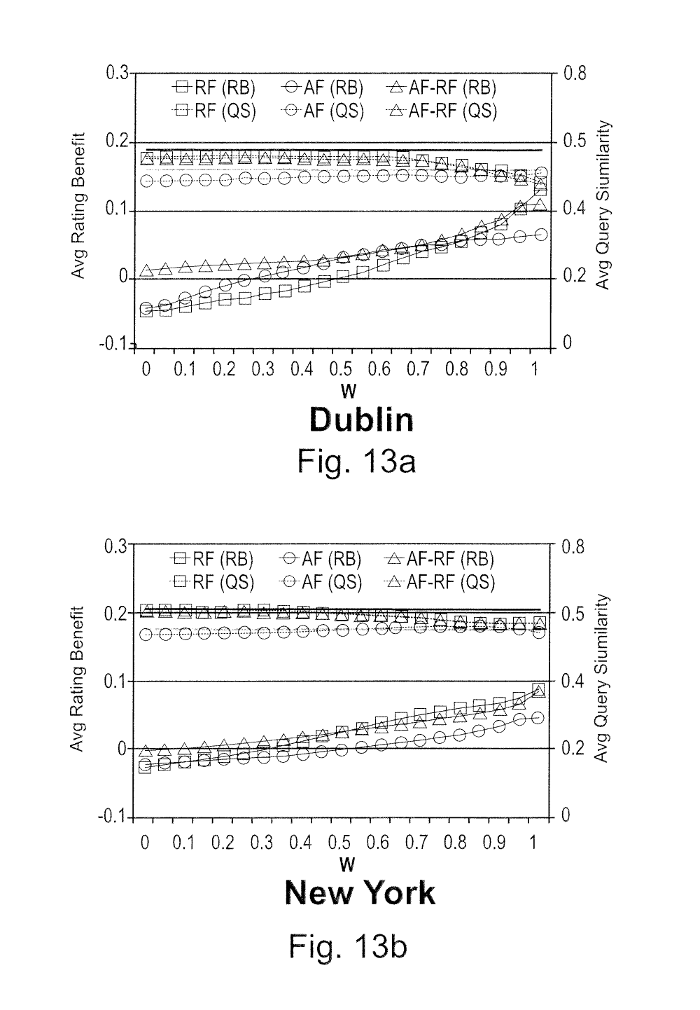

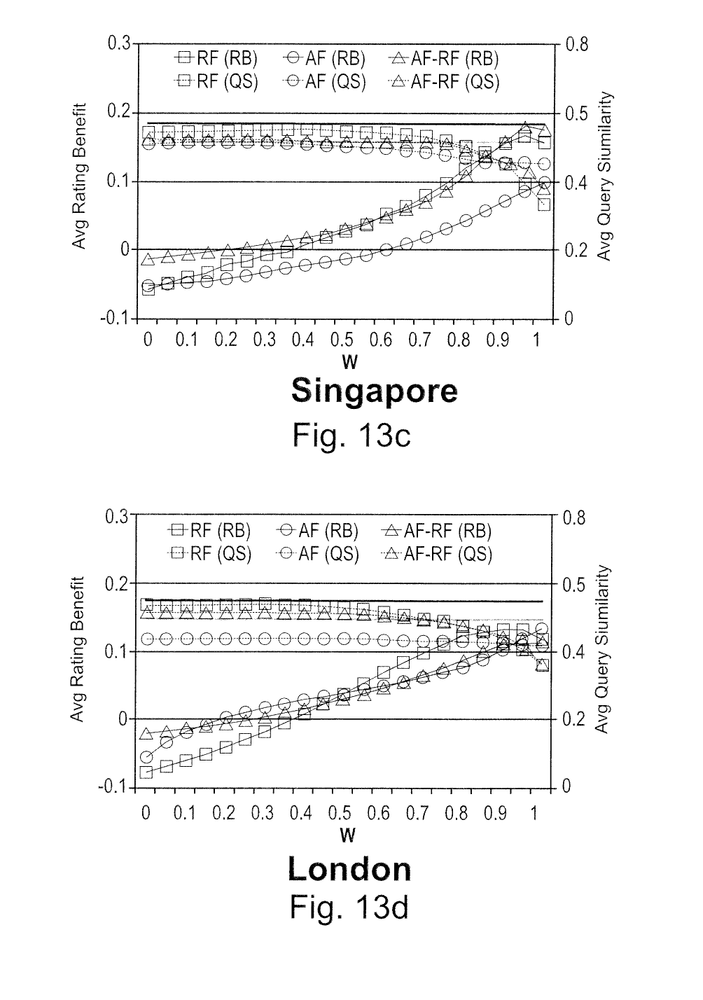

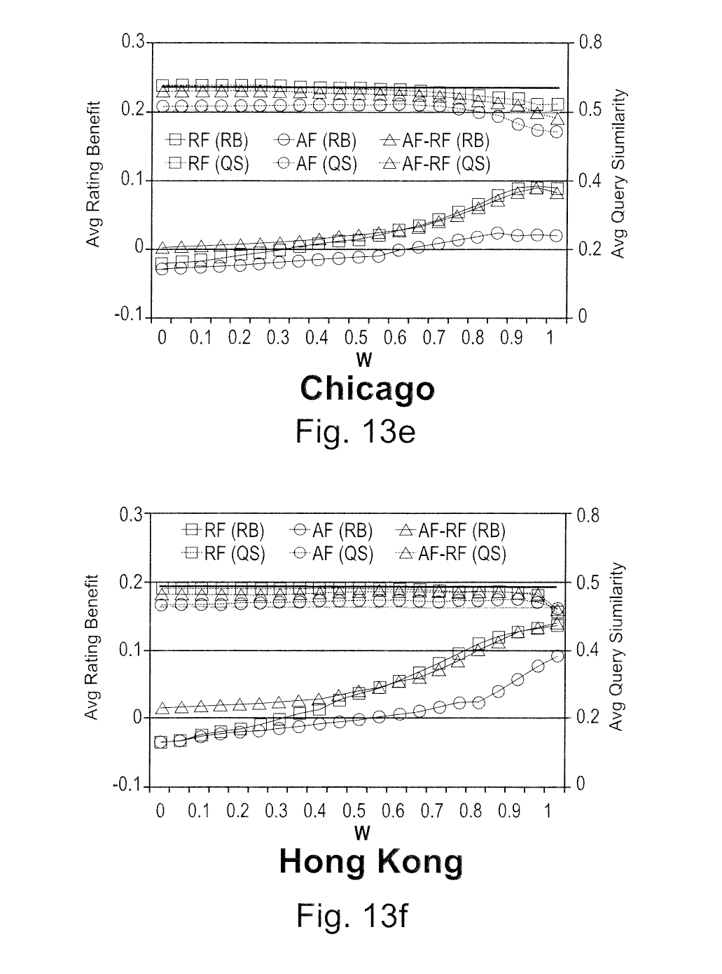

The richness of cases aside, the true test of these approaches of course relates to their ability to generate recommendations that are likely to be of interest to end-users. With this in mind, and as mentioned above, we evaluate the quality of recommendation lists based on their average query similarity and their average ratings benefit. FIGS. 12 and 13 show the results when the B1 and B2 metrics are used to score recommendation candidates, respectively. Six graphs are shown in each Figure, one for each of the cities considered. Each individual graph shows plots for the 3 different algorithmic techniques (AF, RF, and AF-RF), and each algorithmic technique is associated with two plots: a plot of average query similarity (dashed lines) and a plot of average ratings benefit (solid lines) against w. Each graph also shows the average query similarity for the TA default TripAdvisor® recommendations (the black horizontal solid line), and the region between the black and red lines corresponds to the region of 90% similarity; that is, query similarity scores that fall within this region are 90% as similar to the target query as the default recommendations produced by TA. The intuition here is that query similarity scores which fall below this region run the risk of compromising too much query similarity to be useful as more-like-this recommendations.

FIG. 12 shows ratings benefit (RB) and query similarity (QS) using the B1 sentiment metric.

FIG. 13 shows ratings benefit (RB) and query similarity (QS) using the B2 sentiment metric.

Rating Benefit vs. w

There are a number of general observations that can be made about these results. First, as w increases we can see that there is a steady increase in the average ratings benefits and this is consistent across all of the algorithmic and dataset variations. In other words, as we increase the influence of sentiment in the scoring function (Equation 4), we tend to produce recommendations that offer better overall ratings than those produced by TA; thus combining similarity and sentiment in recommendation delivers a positive effect overall. Generally speaking this effect is less pronounced for the AF only variations, especially for values of w above 0.5. For example, in FIG. 12(d), for London hotels (and using B1 for sentiment analysis), we can see that the ratings benefit for AF grows from −0.05 (w=0) to a maximum of 0.05 (w=0:7), whilst the ratings benefit grows from −0.7 (w=0) to 0.18 (at w=0:9) for RF. This suggests that the review features are playing a more significant role in influencing recommendation quality (in terms of ratings benefit) than the amenity features. This is not surprising given the difference in the numbers of amenity and review features extracted from reviews; on average, 4 features were extracted per hotel using the AF approach, compared to 30 features using the RF approach (see Table 1).

Query Similarity vs. w

We can also see that as w increases there is a gradual drop in query similarity. In other words, as we increase the influence of sentiment (and therefore decrease the influence of similarity) in the scoring function (Equation 4), we tend to produce recommendation lists that are increasingly less similar to the target query. On the one hand, this is a way to introduce more diversity into the recommendation process with the added benefit, as above, that the resulting recommendations tend to enjoy a higher ratings benefit compared to the default TripAdvisor® recommendations (TA). But on the other hand, there is the risk that too great a query similarity drop may lead to products that are no longer deemed to be relevant by the end-user. For this reason, we have (somewhat arbitrarily) chosen to prefer query similarities that remain within 90% of those produced by TA. Once again there is a marked difference between the AF approach and those approaches that include review features (RF and AF-RF). The former tends to produce recommendation lists with lower query similarity than either of RF or AF-RF, an effect that is consistent across all 6 cities and regardless of whether B1 or B2 is used in recommendation. For example, consider FIG. 13(d) for London hotels (and using B2 for sentiment analysis). In this case, we can see that the average query similarity for AF starts at about 0.44 (at w=0) and drops to about 0.41 (at w=1), compared to a TA query similarity of about 0.55. In contrast, the RF and AF-RF techniques deliver query similarities in the range 0.36 to 0.54, often within the 90% query similarity range.

Shared vs. Residual Features

In this study we have also tested two variations on how to calculate the sentiment differences between cases: B1 focused just on those features common to both cases whereas B2 considered all features of the cases. In general, the graphs in FIGS. 12 and 13 make it difficult to discern any major difference between these two options across the AF, RF, or AF-RF approaches. Any differences that are found probably reflect the relative importance of shared and residual features among the different city datasets. For example, in the London dataset, B1 seems to produce marginally better ratings benefits at least for RF and AF-RF, whereas the reverse is true for Chicago. It is therefore difficult to draw any significant conclusions at this stage, although in what follows we will argue for a slight advantage for the B2 approach.

A Fixed-Point Comparison

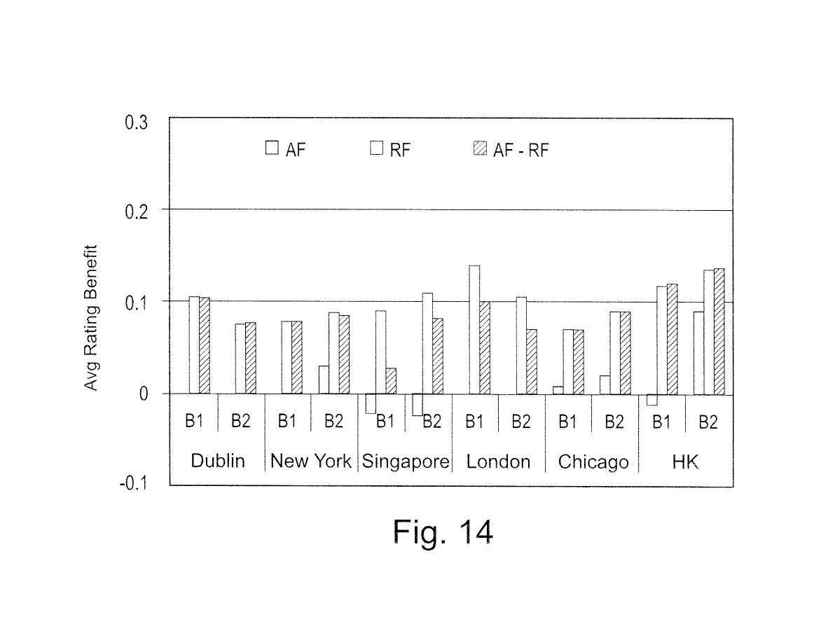

To aid in the evaluation of the different recommendation approaches across the various datasets it is useful to compare the ratings benefits by establishing a fixed point of query similarity. We have highlighted above how favourable ratings benefits tend to come at a query similarity cost, and we have suggested that we might reasonably be wary when query similarity drops below 90% of the level found for the default TA recommendations. With this in mind, we can usefully compare the various recommendation approaches by noting the average ratings benefit available at the value of w for which the query similarity of a given approach falls below the 90% default (TA) query similarity level. For example, in FIG. 12(c), for Singapore hotels and the B1 sentiment analysis technique, we can see that the query similarity for the RF approach falls below the 90% threshold at about w=0:625 and this corresponds to a ratings benefit of 0.09. Performing this analysis for each of the 6 recommendation approaches across the different city datasets gives the ratings benefits represented by the bar chart in FIG. 14. This helps to clarify some the relative differences between the various techniques. For example, the RF technique delivers an average relative ratings benefit of approximately 0.1 (and as high as 0.14 in the case of London and Hong Kong).

FIG. 14 shows summary ratings benefits at the 90% query similarity level.

One of the key questions for this work was the utility of meta-data as a source of review features, which corresponds to the AF approach. In comparison to the above, the AF approaches offer an average ratings benefit of only 0.01, with a maximum benefit of 0.09 (Hong Kong), and sometimes leading to a lower ratings benefit that is available from the default recommendations (TA), as is the case with Singapore. In fact, for London, Dublin, and New York, the AF approach often delivers query similarities that are consistently below the 90% threshold and so do not register any ratings benefit in these cases. Clearly the amenity features used by AF are not providing any significant benefit, and certainly nothing close to that offered by RF, likely because of the relative lack of amenity features compared to review features. Indeed combining amenity and review features, as in the hybrid AF-RF approach, does not generally offer any real advantage over RF alone. The average ratings benefit for AF-RF is 0.087, better than AF but not as good as RF on its own. At best AF-RF provides a ratings benefit that is comparable to that provided by RF (as is the case for Chicago, Dublin, New York, and Hong Kong), but in some cases (Singapore and London) it performs worse than RF.

In this embodiment we have extended the approach to producing product cases from user-generated reviews for the purpose of recommendation. In particular, we have evaluated a number of different approaches to review mining (both with and without meta-data) and have described the results of a large-scale evaluation on TripAdvisor®, hotel reviews across 6 different cities. The results demonstrate the benefit for this embodiment for product recommendation.

As used herein, the term “provider” generally describes the person or entity providing products or services that are reviewed or the reviews themselves. The term “customer” is intended to generally describe a purchaser of products or services who utilizes the method and system described herein. The term “customer” may be used interchangeably with the terms “consumer,” or “user.”

A system for implementing one embodiment of the present invention generally includes a computing device (e.g., an Internet or network enabled device) operated by a consumer and a computer system associated with a provider. The provider's computer system may include one or more servers and one or more computing devices operated by provider employees. This system description contained herein is not intended to be limiting, and one of ordinary skill in the art will recognize that the method and system of the present invention may be implemented using other suitable hardware or software configurations. For example, the system may utilize only a single server implemented by one or more computing devices or a single computing device may implement one or more of the servers and/or provider-employee computing devices. Further, a single computing device may implement more than one step of the method described herein; a single step may be implemented by more than one computing device; or any other logical division of steps may be used.

In one embodiment, the consumer computing device is a desktop or laptop computer that includes an integrated software application configured to operate as a user interface and to provide two-way communication with the provider's computer system. The consumer computing device may also be a portable electronic device, including, but not limited to, a cellular phone, a tablet computer, or a personal data assistant. The portable electronic device can include a screen, a keyboard, a mouse, and one or more buttons, among other features.

Any suitable computing device can be used to implement the consumer computing device or the components of the provider's computer system. The consumer computing device, the provider's servers, and the provider-employee computing devices may include control circuitry, input/output (“I/O”) circuitry, and a processor that communicates with a number of peripheral subsystems via a bus subsystem. These peripheral subsystems may include a storage subsystem, a memory subsystem, a user-interface subsystem, a user-interface output subsystem, and a network-interface subsystem. By processing instructions stored on one or more storage devices, the processor may perform the steps of the present method. Any type of storage device may be used, including an optical storage device, a magnetic storage device, or a solid-state storage device.

The I/O circuitry can be operative to convert analog signals and other signals into digital data. In some embodiments, the I/O circuitry can also convert digital data into any other type of signal, and vice-versa. For example, the I/O circuitry can receive and convert physical contact inputs (e.g., from a tactile interface), physical movements (e.g., from a mouse), or any other input. The digital data can be provided to, and received from, control circuitry, storage, memory, or any other component of the computing device.

The computing device can include any suitable interface or component for allowing a user to provide inputs to I/O circuitry. For example, a computing device can include any suitable input mechanism, such as, for example, a button, keypad, dial, a click wheel, or a touch screen. In some embodiments, the computing device can include specialized output circuitry associated with output devices, such as, for example, one or more displays visible to the user.

The communications subsystem can include any suitable communications circuitry operative to connect to a network and to transmit communications (e.g., voice or data) from the computing device to other computing devices within a network. The communications circuitry can be operative to interface with the network using any suitable communications protocol such as, for example, Wi-Fi (e.g., a 802.11 protocol), cellular network protocols (e.g., GSM or CDMA), internet protocols, or any other suitable protocol.

In a system according to one embodiment of the present invention, consumer-generated, opinionated product reviews are stored in a database on a provider's server. A software process running on the server may search the product reviews to extract a set of candidate product features from the reviews using the methods described herein. The software process then associates the candidate product features with a sentiment label based on the opinions expressed in the review. The sentiment labels may include, for example, positive, negative, or neutral. The features and sentiments are then aggregated at the product level to generate a case of features and overall sentiment scores that are stored in a database on a provider's server.

For each product or service, the software process may also generate one or more recommendations for alternative products or services. The recommendations may be based on the similarity of particular product features or the relative sentiment scores. In this manner, the provider may recommend similar products as well as products that offer improvements over certain features. The one or more recommendations may also be stored in a database on the provider's server.

Consumers may access the provider's computer system using a software application integrated with the consumer's computing device. To access the provider's computer system, the integrated consumer application may use any suitable approach. The integrated software application may contain a user interface for displaying information and accepting input from the consumer. The consumer utilizes the integrated application to search the provider's computer system for information related to products and services. Upon receiving a query from a consumer, the provider's computer system may return a variety of information to the consumer that includes, for example, the recommendations, features, and associated sentiments described herein.

Although the description contained herein provides embodiments of the invention by way of example, it is envisioned that other embodiments may perform similar functions and/or achieve similar results. Any and all such equivalent embodiments and examples are within the scope of the present invention.

The embodiments of the invention described previously with reference to the accompanying drawings comprise a computer system and/or processes performed by the computer system. However the invention also extends to computer programs, particularly computer programs stored on or in a carrier adapted to bring the invention into practice. The program may be in the form of source code, object code, or a code intermediate source and object code, such as in partially compiled form or in any other form suitable for use in the implementation of the method according to the invention. The carrier may comprise a storage medium such as ROM, such as a CD-ROM, or magnetic recording medium, such as a floppy disk or hard disk. The carrier may be an electrical or optical signal which may be transmitted via an electrical or an optical cable or by radio or other means.

The invention is not limited to the embodiments hereinbefore described, with reference to the accompanying drawings, which may be varied in construction and detail.

What is claimed is:

1. A method for recommending a commodity comprising:
accessing one or more commodity reviews;
extracting one or more feature indicators from the one or more commodity reviews, each feature indicator being associated with a feature of a commodity;
extracting one or more sentiment indicators from the one or more commodity reviews, each sentiment indicator being associated with a feature indicator; and
evaluating the one or more sentiment indicators to form a commodity recommendation.

2. A method as claimed in claim 1 wherein evaluating the one or more sentiment indicators comprises classifying each sentiment indicator as being a positive sentiment indicator, a negative sentiment indicator, or a neutral sentiment indicator.

3. A method as claimed in claim 2 wherein evaluating the one or more sentiment indicators comprises determining the number of positive sentiment indicators associated with a first feature indicator.

4. A method as claimed in claim 3 wherein evaluating the one or more sentiment indicators comprises determining the number of negative sentiment indicators associated with the first feature indicator.

5. A method as claimed in claim 4 wherein evaluating the one or more sentiment indicators comprises determining the difference between the number of positive sentiment indicators associated with the first feature indicator and the number of negative sentiment indicators associated with the first feature indicator.

6. A method as claimed in claim 1 wherein evaluating the one or more sentiment indicators comprises evaluating one or more sentiment indicators associated with a first commodity, and evaluating one or more sentiment indicators associated with a second commodity.

7. A method as claimed in claim 6 wherein evaluating the one or more sentiment indicators comprises determining the difference between the one or more sentiment indicators associated with the first commodity and the one or more sentiment indicators associated with the second commodity.

8. A method as claimed in claim 7 wherein evaluating the one or more sentiment indicators comprises determining the difference for each feature indicator in common between the first commodity and the second commodity.

9. A method as claimed in claim 8 wherein evaluating the one or more sentiment indicators comprises aggregating the differences for each feature indicator in common between the first commodity and the second commodity.

10. A method as claimed in claim 7 wherein evaluating the one or more sentiment indicators comprises determining the difference for each feature indicator of the first commodity and for each feature indicator of the second commodity.

11. A method as claimed in claim 10 wherein evaluating the one or more sentiment indicators comprises assigning a neutral sentiment indicator for each feature indicator not in common between the first commodity and the second commodity.

12. A method as claimed in claim 11 wherein evaluating the one or more sentiment indicators comprises aggregating the differences for each feature indicator of the first commodity and for each feature indicator of the second commodity.

13. A method as claimed in claim 1 wherein a first feature indicator is extracted from a plurality of commodity reviews.

14. A method as claimed in claim 13 wherein the method comprises determining the number of commodity reviews from which the first feature indicator is extracted to form a popularity indicator.

15. A method as claimed in claim 1 wherein the method comprises determining a similarity indicator between a first commodity and a second commodity.

16. A method as claimed in claim 15 wherein determining the similarity indicator comprises aggregating the popularity indicator for each feature indicator of the first commodity and aggregating the popularity indicator for each feature indicator of the second commodity.

17. A method as claimed in claim 16 wherein determining the similarity indicator comprises aggregating the popularity indicator for each feature indicator of the first commodity and aggregating the popularity indicator for each feature indicator of the second commodity in a cosine metric, or in a Jaccard metric, or in an overlap metric.

18. A method as claimed in claim 15 wherein the method comprises evaluating the similarity indicator to form the commodity recommendation.

19. A method as claimed in claim 1 wherein the method comprises delivering the commodity recommendation.

20. A method as claimed in claim 19 wherein the commodity recommendation comprises a recommendation indicator, the recommendation indicator being associated with a second commodity.

21. A system for recommending a commodity, the system comprising:
means for accessing one or more commodity reviews;
means for extracting one or more feature indicators from the one or more commodity reviews, each feature indicator being associated with a feature of a commodity;
means for extracting one or more sentiment indicators from the one or more commodity reviews, each sentiment indicator being associated with a feature indicator; and
means for evaluating the one or more sentiment indicators to form a commodity recommendation.

22. A computer program product comprising computer program code capable of causing a computer system to perform a method as claimed in claim 1 when the computer program product is run on a computer system.
